(19) United States
(12) Patent Application Publication
(10) Pub. No.: US 2026/0178695 A1
(43) Pub. Date: Jun. 25, 2026

(54) ESTIMATING A PROPERTY OF A SEMICONDUCTOR DEVICE USING A QUANTUM COMPUTING DEVICE

(71) Applicant: Telefonaktiebolaget LM Ericsson (publ), Stockholm (SE)

(72) Inventors: Ahsan Javed AWAN, Vallentuna (SE); Anders WINKA, Uppsala (SE); Rui HOU, Täby (SE)

(73) Assignee: Telefonaktiebolaget LM Ericsson (publ), Stockholm (SE)

(21) Appl. No.: 19/125,815

(22) PCT Filed: Nov. 1, 2022
(86) PCT No.: PCT/SE2022/051002

§ 371 Date: Apr. 30, 2025

(51) Int. Cl. G06F 17/16; G06N 10/00

(52) U.S. Cl. CPC G06F 17/16; G06N 10/00

(57) ABSTRACT

Methods and apparatuses for estimating a property of a semiconductor device using a quantum computing device are provided. A method comprises initializing a first system of equations based on one or more parameters relating to a spatially discretized representation of the semiconductor device, applying a method of cyclic reduction to the first system of equations to obtain a second system of equations which reduces the computational complexity of the method; and estimating the property of the semiconductor device based on the solution to the second system of equations. A method comprises determining entries of a matrix B that is the inverse of a matrix A, where the entries of the matrix A represent interactions within a layer of a spatially discretized representation of a semiconductor device, by formulating a quadratic unconstrained binary optimization, QUBO, problem, and executing the QUBO problem on a quantum computing device.

### TECHNICAL FIELD

Examples of the present disclosure relate to estimating a property of a semiconductor device. Examples of the present disclosure also relate to determining entries of a N×N matrix B, where the matrix B is the inverse of a N×N matrix A, for example using a method that uses a quantum computing device.

### BACKGROUND

The evolution of 5G towards increased connectivity, intelligent network platforms and edge computing requires significant computing power in the telecommunications infrastructure.

The doubling of transistor density on an integrated chip every 2 years (known as Moore's law), combined with the enhanced performance of individual transistors, has led to tremendous developments in the capabilities of electronic devices. The performance demands of new application may be fulfilled using new sub-10 nm transistor technologies (for example, gate-all-around (GAA) 3-nm transistors), where the electrical, thermal, and switching characteristics of these transistors are dominated by quantum effects. Modeling these quantum effects accurately improves the integrity of circuit design in this area.

Traditionally, semiconductor devices have been analysed by simulating electron transport using semiclassical methods based on the Boltzmann transport equation (BTE), or moments of the BTE, such as the drift-diffusion model or the hydrodynamics model. However, when a semiconductor device shrinks to a point where the de Broglie wavelength of the electrons is comparable to the size of the semiconductor device, wave characteristics cannot be ignored. At this point, semi-classical transport equations cease to be valid, as they cannot treat the quantum effects accurately. There is therefore a need for methods of simulating a semiconductor device which can incorporate quantum effects to enable the discovery and development of modern nano electronic devices.

There exist models capable of modelling these quantum effects (known as quantum models), such as the self-consistent solution of the Schrödinger equation with open boundary conditions. These models can more accurately simulate nanoscale devices compared to the drift diffusion model, but at the cost of increased computational complexity. The computational complexity of quantum models reduces their useability. Simulation domains using these models are often limited to two dimensions, when in fact transistors are three-dimensional devices, and the simulation times of these models can be very long.

However, improving supercomputers and quantum computers offer new opportunities for quantum models to be facilitated for simulating semiconductor devices.

Firstly considering macroscopic approaches, efforts have been made to implement quantum effects in macroscopic device simulators as the semiconductor device size shrinks. One approach is based on the moment equations derived from the Wigner distribution function, known as the density gradient (DG) method [2]. The Wigner distribution satisfies a microscopic transport equation derived from the quantum Liouville equation, where a quantum correction term is added. Calculating the first-order moment of this transport equation gives a macroscopic current continuity equation which is used in the density gradient method. The DG method is embedded into the drift diffusion model to compensate for the statistical quantum effects [3].

For microscopic approaches, the electron is guided by both the classical electrostatic potential and the quantum potential, which can be implemented in the Monte Carlo technique. This approach can account for static quantum interference effects due to the nonlocal wave nature of the particle. Depending on the assumptions and approximations used in its derivation, many different varieties of quantum potential can be obtained, such as the DG method, the quantum moment method [13] and the smoothed effective potential [14]. Static quantum effects caused by the potential profile inside the semiconductor device can be accounted for with the quantum potential. However, this approach assumes a closed system, and therefore it is not easy to account for dynamical quantum effects associated with phase randomizing scattering processes.

To capture the dynamical quantum effects, it is necessary to solve the quantum transport equation for the entire system and its environment (such as phonons). Several techniques can handle the dynamical quantum effects, for example the density matrix (using a Wigner distribution for an open system, but not the closed system associated with the quantum potential) approach, the master equation approach, and the nonequilibrium Green's function approach.

To capture the random phase scatterings in sub-10 nm transistors, it has been suggested to replace semiclassical BTE by the master equation [6,15,16] based on the natural basis, composed of the eigenstates of the self-consistent Hartree potential in the Schrödinger equation in the density matrix. This approach assumes that off diagonal elements of the density matrix in the natural basis are negligible. This means that the transition of an electron's state is approximated as a completed collision and Markovian. Comparing the master equation approach to the BTE, the deviations of electron transport characteristics (such as the electron density, drift velocity and average energy) are small.

A non-equilibrium Green function (NEGF) approach requires several Green functions (proper correlation functions) in addition to the retarded and the advanced Green's function, to describe nonequilibrium transport. The Green functions satisfy the Dyson 2×2 matrix equation. This approach introduces a self-energy function to capture scattering processes and interactions with the semiconductor device environment. This approach has been applied to simulate electron transport under high electric fields and quantum effects such as collisional broadening and intra-collisional effects. Because of the approximation (Born) in the scattering kernel, it is uncertain of the importance of these quantum effects. This approach has also been applied to nanostructure devices.

It is noted that certain existing techniques for simulating semiconductor devices, such as the density matrix (Wigner distribution) approach, master equation approach, and nonequilibrium Green's function approach, are very computationally involved. As such, these approaches are limited to simulating one-dimensional structures (for example, see [3]).

Microscopic approaches identify the shortcomings of the semiclassical BTE approach, and represent the foundation of the next generation of simulators. However, as these approaches are much more involved, they are much more computationally complex.

Now considering the Schrödinger equation with open boundaries, the goal when solving the Schrödinger equation is to study the behavior of the semiconductor device under an applied bias (for example, drain-source voltage), where particles can be exchanged with the environment through contacts. To treat the interaction with the environment, the quantum transmitting boundary method (QTBM) is used. The source and drain contacts are idealized as infinite leads connected to the active region of the device. Electron waves are then injected from the leads, and their distribution inside the semiconductor device, and the current into the leads, is calculated.

After discretization of the Schrödinger equation with the finite element method, using rectangular mesh elements, and imposing the open-boundary conditions with the QTBM, a sparse linear system of equations Hφ=b is obtained as follows:

$$[ {H}^{D} + {\sum }_{L} + {\sum }_{R} - {E}_{β}^{v} I ] {Φ}_{m , b}^{s v} = {B}^{m} \qquad ( 1 )$$

where H^{D} is the N×N Schrödinger Hamiltonian, I is the N×N identity matrix, B^{m} is a N×1 vector of the injected modes into the semiconductor device, and Σ_{L} and Σ_{R} are N×N matrices representing the self-energy (including the reflected and transmitted (traveling and evanescent) waves traveling into and out of the semiconductor device). Σ_{L} and Σ_{R} are calculated with the QTBM. The interfaces where no electrons are injected Γₒ have zero-value Dirichlet boundary conditions implemented. Equation 1 is then solved to obtain the electron wave vectors

$${Φ}_{m , {b}^{′}}^{s , v} ,$$

for different injection energies

$${E}_{{β}^{′}}^{v} ,$$

traveling modes m, leads s, and conduction-band valleys v. The obtained electron wave vectors are then used to calculate the density of states [6].

To enable the exploitation of the parallel capabilities of supercomputers and/or quantum computers, a domain decomposition (DD) method can be utilized in order to solve a boundary value problem by splitting it into smaller boundary value problems on subdomains and iterating to coordinate the solution between adjacent subdomains.

Quantum computers are limited by their number of logical qubits, and cannot therefore solve large problems. As domain decomposition methods enable large problems to be reduced to several smaller subproblems, domain decomposition methods enable these larger problems (such as solving a discretized Schrödinger equation for a semiconductor device), to be implemented on quantum computers according to current limitations.

Implementing a DD method as part of a method of simulating a semiconductor device therefore enables the execution time of the simulation to be improved, by enabling the subproblems to be solved simultaneously using parallel computing and/or allowing the subproblems to be solved using a quantum computing device.

An example of a domain decomposition method is the block cyclic reduction (BCR) method [4], also be known as “renormalization” [5].

The BCR method exploits the structure of a system of linear equations to then allow Gaussian elimination to be used to decouple matrix blocks. In equation 1, the matrix blocks correspond to different layers of the semiconductor device, where the layers of the semiconductor device are coupled to one another. Therefore, by decoupling the matrix blocks, the BCR method enables the different layers of the semiconductor device to be decoupled until a system of linear equations is formed in which only the first layer and the last layer are coupled.

In the BCR method, a layer i of the semiconductor device is decoupled by “renormalizing” the matrix blocks H_{i-1,i-1}, H_{i+1,i+1}, H_{i-1,i+1} and H_{i+1,i-1} as follows:

$${X}_{i} = {H}_{i , i}^{- 1} {H}_{i , i - 1} \qquad ( 2 a )$$

$${Y}_{i} = {H}_{i , i}^{- 1} {H}_{i , j + 1} \qquad ( 2 b )$$

$${\hat{H}}_{i - 1 , i - 1} = {H}_{i - 1 , i - 1} - {H}_{i - 1 , i} {X}_{i} \qquad ( 2 c )$$

$${\hat{H}}_{i + 1 , i + 1} = {H}_{i + 1 , i + 1} - {H}_{i + 1 , i} {Y}_{i} \qquad ( 2 d )$$

$${\hat{H}}_{i - 1 , i + 1} = {H}_{i - 1 , i} {Y}_{i} \qquad ( 2 e )$$

$${\hat{H}}_{i + 1 , i - 1} = {\hat{H}}_{i - 1 , i + 1}^{†} \qquad ( 2 f )$$

where i−l and i+r are the indices of the layers of the semiconductor device that are presently coupled to layer l, and Ĥ denotes a matrix block H after renormalization.

These six operations suppress the layer i from H. The BCR method can suppress all the layers of the semiconductor device, apart from the first layer and the last layer, in this manner.

The BCR method may be divided into three stages:

In a first stage, matrix blocks with even indices are decoupled (2, 4, 6, . . . ), with exception of the last layer if that has an even index.

In a second stage, half of the odd indexed matrix blocks are decoupled (3, 7, 11, . . . ). This includes the inversion of, and the multiplication of, real dense matrices.

In a third stage, the remaining half of the matrix blocks with odd indices are decoupled (5, 9, 13, . . . ). All the matrices in this stage are full. This process is then repeated until only the matrix blocks Ĥ_{1,1}, Hₙ_{ₓ}_{,n}_{ₓ}, Ĥ_{1,n}_{ₓ}, and Ĥₙ_{ₓ}_{,1} are left.

Following the execution of the BCR method, a system of linear equations is formed in which only the first layer and the last layer are coupled (that is, a 2n_{z}×2n_{z} linear system of equations).

The BCR method therefore require a solution of nₓ−2 inverses of size n_{z}×n_{z}, and a 2n_{z}×2n_{z} linear system of equations, to be determined, rather than a nₓn_{z}×nₓn_{z} system of linear equations (that is, the initial system of equations).

The 2n_{z}×2n_{z} linear system of equations is then solved to determine the entries Φ₁ and Φₙ_{ₓ} of the solution vector Φ.

The rest of the solution vector Φ can then reconstructed using the following equation, for each entry Φᵢ:

$${Φ}_{i} = - {X}_{i} {Φ}_{i - l} - {Y}_{i} {Φ}_{i + r} \qquad ( 2 g )$$

Where Φᵢ₋ₗ and Φᵢ₊ᵣ are the entries of the solution vector corresponding to the layers that layer i was previously coupled to prior to layer i being decoupled. That is, the entry Φᵢ is reconstructed based on the layers that layer i was coupled to prior to the decoupling of the layer.

In this manner, the full solution Φ can be recursively reconstructed.

The BCR method has been applied for atomistic simulation, where the linear system of equations used in this simulation comprises diagonal matrix blocks which in themselves are diagonal (see FIG. 1. in [10], for example). It is noted that this makes the necessary computation of matrix inverses simpler. However, the atomistic simulation requires solutions to be determined for several linear systems of equations.

Quantum Annealers are a class of quantum computers and are rapidly emerging as a target hardware platform to efficiently solve combinatorial optimization problems. Quantum annealers frame these problems as energy minimization problems, and implement a metaheuristic procedure called quantum annealing to find the low-energy states of the problem, and therefore the optimal combination of variables that yield the global optima of the objective function.

For a quantum system, a Hamiltonian is a function which maps certain states, called eigenstates, to corresponding eigen energies. The collection of these eigen energies make up the eigen spectrum. The Hamiltonian can be viewed as the sum of two terms: (i) an initial Hamiltonian, whose lowest-energy state is when all the qubits are in a superposition state of 0 and 1; (ii) a final Hamiltonian or problem Hamiltonian, whose lowest-energy state is the solution to the problem that is being solved. The quantum annealing process initializes the system in the lowest-energy eigenstate of the initial Hamiltonian. Then, it gradually increases the influence of the problem Hamiltonian, which contains the qubit biases and coupling strengths between qubits, and slowly decreases the influence of the initial Hamiltonian. At the end of the quantum annealing process, the system will be in the eigenstate of the problem Hamiltonian. Ideally, the system stays in a minimum energy state throughout the quantum annealing process such that, at the end of the process, the system is in the minimum energy state of the problem Hamiltonian, and therefore provides a solution to the problem. By the end of the anneal, each qubit is a classical object.

Reference [11] describes a QUBO formulation to compute inverses of matrices. The inverse of a N×N matrix A can be determined by solving a linear system of equations Ax=m, where m is a unit vector (for example m=e₁=[1, 0, . . . , 0]^{T}). The solution to this linear system of equations, with the right-hand-side m=e₁, will be the first column of A⁻¹. Therefore, by solving the linear system of equations for all unit vectors, A⁻¹ can be determined. However, this method requires the linear system of equations to be solved N times, determining N unknown variables each time.

As noted above, for methods of simulating a semiconductor device that solve a discretized Schrödinger equation for the semiconductor device, the discretized Schrödinger equation is solved to obtain the electron wave vectors

$${Φ}_{m , {b}^{′}}^{s , v} ,$$

for different injection energies

$${E}_{{β}^{′}}^{v} ,$$

traveling modes m, leads s, and conduction-band valleys v. That is, the discretized Schrödinger equation must be solved many times, for many different device states, as part of the simulation method, and may therefore represent a “bottleneck” in the execution time of the method. Furthermore, computing the inverse matrices required to determine each of these different solutions to the discretized Schrödinger equation is computationally expensive and time-consuming. Although the BCR method may be utilized to reduce the computational burden of determining a solution to each discretized Schrödinger equation, the BCR method itself requires the computation of inverse matrices. It is also noted that, if the first and last entries of the solution vector, (determined using the BCR method) are equal to zero, it is not possible to determine a nonzero solution for the solution vector using the BCR method.

Therefore, there is a need for improved methods of estimating a property of a semiconductor device, that are capable of estimating a property of a semiconductor device more accurately and/or are capable of being executed more quickly and/or are less computationally expensive.

### SUMMARY

A first aspect of the present disclosure provides a method of estimating a property of a semiconductor device. The method comprises:
forming a spatially discretized representation of the semiconductor device comprising nₓ layers;
initializing a first system of equations based on one or more parameters relating to the spatially discretized representation of the semiconductor device, wherein the first system of equations represent the property of the semiconductor device, wherein each equation of the first system of equations represents layer i, where i=(1, 2, . . . nₓ₋₁, nₓ), and comprises one or more matrix blocks H_{i,j}, where j=(1, 2, . . . nₓ₋₁, nₓ), and wherein each matrix block represents either:
   one or more interactions within layer i, or
   one or more interactions between a layer i, and a layer adjacent to layer i in the spatially discretized representation;
applying a method of cyclic reduction to the first system of equations to obtain a second system of equations;
determining a solution to the second system of equations; and
estimating the property of the semiconductor device based on the solution to the second system of equations.

Another aspect of the present disclosure provides a method of determining entries of a N×N matrix B, where the matrix B is the inverse of a N×N matrix A. The method comprises:
for each entry of B, forming a representation of the entry of B that comprises one or more binary variables;
forming, based on the representations of the entries of B, N² linear equality constraints that represent A·B=I, where I is an N×N identity matrix;
formulating a quadratic unconstrained binary optimization, QUBO, problem based on the N² linear equality constraints;
executing the QUBO problem on a quantum computing device to obtain a set of values of the binary variables; and
using the set of values of the binary variables to determine the entries of matrix B.

A further aspect of the present disclosure provides a method, performed on a data processing apparatus, of determining entries of a N×N matrix B for use in a method of estimating a property of a semiconductor device, where the matrix B is the inverse of a N×N matrix A, and where the entries of the matrix A represent interactions within a layer of a spatially discretized representation of the semiconductor device. The method comprises:
for each entry of B, forming a representation of the entry of B that comprises one or more binary variables;
forming, based on the representations of the entries of B, N² linear equality constraints that represent A·B=I, where I is an N×N identity matrix;
formulating a quadratic unconstrained binary optimization, QUBO, problem based on the N² linear equality constraints;
executing the QUBO problem on a quantum computing device to obtain a set of values of the binary variables; and
using the set of values of the binary variables to determine the entries of matrix B.

A still further aspect of the present disclosure provides an apparatus for estimating a property of a semiconductor device. The apparatus is configured to:
form a spatially discretized representation of the semiconductor device comprising nₓ layers;
initialize a first system of equations based on one or more parameters relating to the spatially discretized representation of the semiconductor device, wherein the first system of equations represent the property of the semiconductor device, wherein each equation of the first system of equations represents layer i, where i=(1, 2, . . . nₓ₋₁, nₓ), and comprises one or more matrix blocks H_{i,j}, where j=(1, 2, . . . nₓ₋₁, nₓ), and wherein each matrix block represents either:
   one or more interactions within layer i, or
   one or more interactions between a layer i, and a layer adjacent to layer i in the spatially discretized representation;
apply a method of cyclic reduction to the first system of equations to obtain a second system of equations;
determine a solution to the second system of equations; and
estimate the property of the semiconductor device based on the solution to the second system of equations.

A still further aspect of the present disclosure provides an apparatus for determining entries of a N×N matrix B, where the matrix B is the inverse of a N×N matrix A. The apparatus is configured to:
for each entry of B, form a representation of the entry of B that comprises one or more binary variables;
form, based on the representations of the entries of B, N² linear equality constraints that represent A·B=I, where I is an N×N identity matrix;
formulate a quadratic unconstrained binary optimization, QUBO, problem based on the N² linear equality constraints;
execute the QUBO problem on a quantum computing device to obtain a set of values of the binary variables; and
use the set of values of the binary variables to determine the entries of matrix B.

A still further aspect of the present disclosure provides a data processing apparatus for determining entries of a N×N matrix B for use in a method of estimating a property of a semiconductor device, where the matrix B is the inverse of a N×N matrix A, and where the entries of the matrix A represent interactions within a layer of a spatially discretized representation of the semiconductor device. The data processing apparatus is configured to:
for each entry of B, form a representation of the entry of B that comprises one or more binary variables;
form, based on the representations of the entries of B, N² linear equality constraints that represent A·B=I, where I is an N×N identity matrix;
formulate a quadratic unconstrained binary optimization, QUBO, problem based on the N² linear equality constraints;
execute the QUBO problem on a quantum computing device to obtain a set of values of the binary variables; and
use the set of values of the binary variables to determine the entries of matrix B.

### BRIEF DESCRIPTION OF THE FIGURES

For a better understanding of examples of the present disclosure, and to show more clearly how the examples may be carried into effect, reference will now be made, by way of example only, to the following Figures in which:

FIG. 1 illustrates a method 100 of estimating a property of a semiconductor device;

FIG. 2 illustrates an example of a spatially discretized representation of a semiconductor device 200, comprising plurality of layers 208a . . . 208e;

FIG. 3a illustrates the matrix structure of the matrix H of equation 3;

FIG. 3b illustrates a matrix structure of the matrix H obtained following the execution of a first stage of a BCR method;

FIG. 3c illustrates the matrix structure of the matrix H obtained following the execution of a second stage of a BCR method;

FIG. 4 illustrates a method 400 of determining entries of a N×N matrix B, where the matrix B is the inverse of a N×N matrix A;

FIG. 5 illustrates a method 500, performed on a data processing apparatus, of determining entries of a N×N matrix B for use in a method of estimating a property of a semiconductor device, where the matrix B is the inverse of a N×N matrix A, and where the entries of the matrix A represent interactions between coupled layers of a spatially discretized representation of the semiconductor device;

FIG. 6 illustrates a method 600 of simulating a semiconductor device;

FIG. 7 illustrates an initial potential distribution for a resonant tunneling device;

FIG. 8a illustrates the root mean square error for different Type 1 energies;

FIG. 8b illustrates the root mean square error for different Type 2 energies;

FIG. 9a illustrates the wave function of the RTD for the 10th Type 2 energy, obtained using the linear equation solver;

FIG. 9b illustrates the wave function of the RTD for the 10th Type 2 energy, obtained using the regular BCR method;

FIG. 9c illustrates the wave function of the RTD for the 10th Type 2 energy, obtained using the additional layer BCR method;

FIG. 10 illustrates the speed up of the whole matrix approach compared to unit vector approach;

FIG. 11 illustrates the embedding overhead for the whole matrix approach compared to unit vector approach;

FIG. 12 illustrates the qubit requirements for both the whole matrix approach and the unit vector approach;

FIG. 13 illustrates the resource efficiency for both the whole matrix approach and the unit vector approach;

FIG. 14 is a schematic of an example of an apparatus 1400 for estimating a property of a semiconductor device;

FIG. 15 is a schematic of an example of an apparatus 1500 for entries of a N×N matrix B, where the matrix B is the inverse of a N×N matrix A; and

FIG. 16 is a schematic of an example of a data processing apparatus 1600 for determining entries of a N×N matrix B for use in a method of estimating a property of a semiconductor device, where the matrix B is the inverse of a N×N matrix A, and where the entries of the matrix A represent interactions within a layer of a spatially discretized representation of the semiconductor device.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments of the present disclosure relate to improved methods of estimating a property of a semiconductor device. Some embodiments herein aim to estimate a property of a semiconductor device more accurately. Some embodiments herein aim to reduce the execution time of estimating a property of a semiconductor device.

In particular, some embodiments relate to methods of estimating a property of a semiconductor device that employ a method of cyclic reduction that selects an additional layer of the semiconductor device to remain coupled to the first and last layers of the semiconductor device. This then enables a solution to be reconstructed based on the solution determined for the additional layer of the semiconductor device, as well the solutions determined for the first and last layer respectively, improving the accuracy of the obtained solution.

In particular. some embodiments improve the accuracy of an obtained solution for a discretized Schrödinger equation for a semiconductor device.

Some embodiments relate to accelerated methods of determining entries of a N×N matrix B, where the matrix B is the inverse of a N×N matrix A, using a quantum computing device. These embodiments can determine the inverse of a N×N matrix A approximately three times faster than prior art methods (see [11]).

These methods may be utilized as part of the methods of estimating a property of a semiconductor device described. For example, these accelerated methods of determining entries of a N×N matrix B, where the matrix B is the inverse of a N×N matrix A may be utilized as part of a method of cyclic reduction in a method of estimating a property of a semiconductor device.

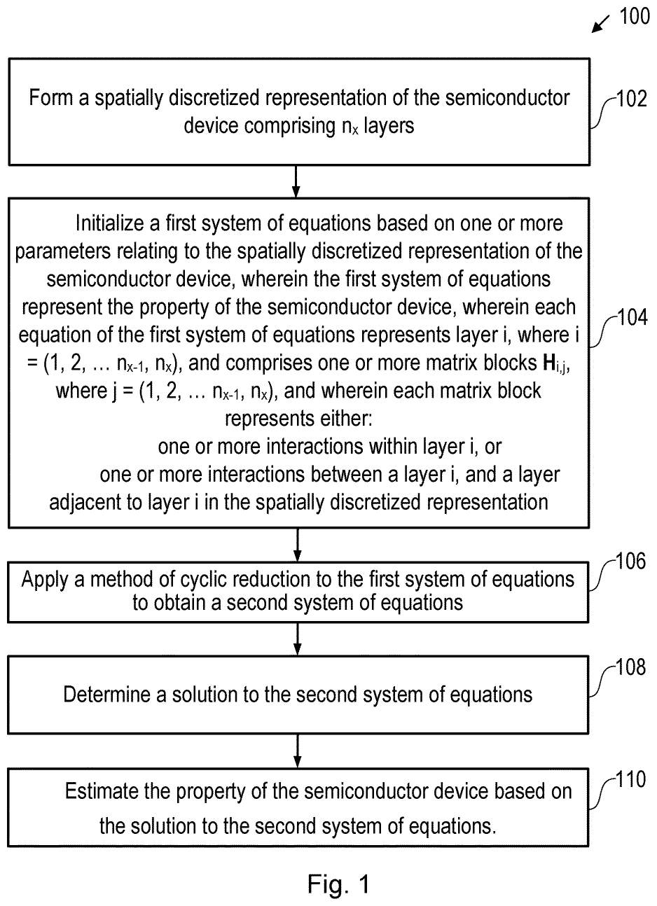

FIG. 1 illustrates a method 100 of estimating a property of a semiconductor device.

At step 102, the method 100 comprises forming a spatially discretized representation of the semiconductor device comprising nₓ layers.

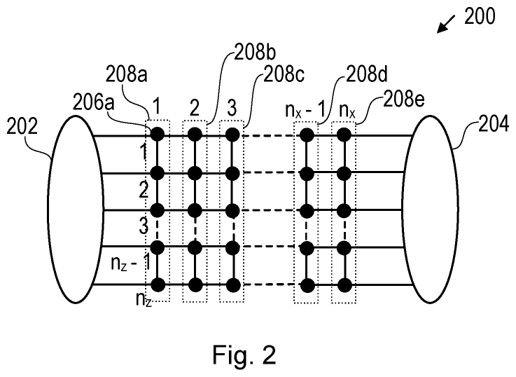

In some embodiments, each layer of the spatially discretized representation of the semiconductor device comprises one or more nodal points. An example of a spatially discretized representation of a semiconductor device is shown in FIG. 2.

In some embodiments, forming a spatially discretized representation of the semiconductor device comprises using a finite element method. In some embodiments, using the finite element method to form the spatially discretized representation of the semiconductor device comprises using rectangular mesh elements, where each rectangular mesh element represents a spatial portion of the device.

At step 104, the method 100 comprises initializing a first system of equations based on one or more parameters relating to the spatially discretized representation of the semiconductor device, wherein the first system of equations represent the property of the semiconductor device, wherein each equation of the first system of equations represents layer i, where i=(1, 2, . . . nₓ₋₁, nₓ), and comprises one or more matrix blocks H_{i,j}, where j=(1, 2, . . . nₓ₋₁, nₓ), and wherein each matrix block represents either:
one or more interactions within layer i, or
one or more interactions between a layer i, and a layer adjacent to layer i in the spatially discretized representation.

That is, the first system of equations represent each layer of the spatially discretized representation of the semiconductor device as being coupled to its adjacent layers.

In some embodiments, the first system of equations comprises a two-dimensional Schrödinger equation for the spatially discretized representation of the semiconductor device. In these embodiments, the first system of equations comprises, for layer of the spatially discretized representation of the semiconductor device, a Schrödinger equation initialized for that layer. In these embodiments, the property may comprise the wave function in the semiconductor device.

For example, a first system of equations comprising a Schrödinger equation initialized for each layer in a spatially discretized representation of a semiconductor device may be expressed as follows:

$$[ \begin{matrix}{H}_{1 , 1}^{D} + {\sum }_{L} - EI & {H}_{1 , 2}^{D} & 0 & … & 0 \\ {H}_{2 , 1}^{D} & {H}_{2 , 2}^{D} - EI & {H}_{2 , 3}^{D} & ⋱ & ⋮ \\ 0 & ⋱ & ⋱ & ⋱ & 0 \\ ⋮ & ⋱ & ⋱ & ⋱ & {H}_{{n}_{x} - 1 , {n}_{x}}^{D} \\ 0 & … & 0 & {H}_{{n}_{x} - 1 , {n}_{x}}^{D} & {H}_{{n}_{x} , {n}_{x}}^{D} + {\sum }_{R} - EI\end{matrix} ] [ \begin{matrix}{Φ}_{1} \\ {Φ}_{2} \\ ⋮ \\ ⋮ \\ {Φ}_{{n}_{x}}\end{matrix} ] = [ \begin{matrix}{B}_{1} \\ 0 \\ ⋮ \\ ⋮ \\ 0\end{matrix} ] \qquad ( 2 )$$

In this example, each layer in the spatially discretized representation comprises n_{z} nodal points. Therefore, in this example, the elements in the matrices of equation 3 are themselves matrices of size n_{z}×n_{z} (corresponding to the n_{z} nodal points comprised within each of the layers). In this example, each of the diagonal elements in equation 3 describe interactions within a layer of the spatially discretized representation. For example, the element

$${H}_{1 , 1}^{D} + {\sum }_{L} - EI$$

describes interactions within layer 1 of the spatially discretized representation. In this example, each of the off diagonal elements in equation 3 describe interactions between adjacent layers of the spatially discretized representation. For example, the element

$${H}_{1 , 2}^{D}$$

describes interactions between layer 1 and layer 2 of the spatially discretized representation.

In some embodiments, where first system of equations comprises a two-dimensional Schrödinger equation for the spatially discretized representation of the semiconductor device, initializing the first system of equations based on one or more parameters relating to the spatially discretized representation of the semiconductor device may comprise initializing the first system of equations based on one or more of: one or more injected modes into the device, the self-energy of the device.

In some embodiments, where first system of equations comprises a two-dimensional Schrödinger equation for the spatially discretized representation of the semiconductor device, the property of the semiconductor device represented by the first system of equations comprises a wave function of the semiconductor device.

For example, in equation 3, the wave function of the semiconductor device is represented by the vector Φ. Each entry of the vector Φ then corresponds to the wave function of a particular layer of the semiconductor device (for example, Φ₁ represents the wave function in layer 1 of the semiconductor device).

As noted above, each equation in the first system of equations represents a layer of the spatially discretized representation of the semiconductor device. Therefore, for each equation in the first system of equations, solving the equation enables the property in the corresponding layer of the semiconductor device to be determined.

In some embodiments, the first system of equations comprises a two-dimensional Poisson equation for the spatially discretized representation of the semiconductor device. In these embodiments, the first system of equations comprises, for layer of the spatially discretized representation of the semiconductor device, a Poisson equation initialized for that layer. In these embodiments, the property of the semiconductor device may comprise an electrostatic potential in the semiconductor device.

At step 106, the method 100 comprises applying a method of cyclic reduction to the first system of equations to obtain a second system of equations.

In some embodiments, the method of cyclic reduction may comprise a block cyclic reduction method.

As noted above, applying a method of cyclic reduction to the first system of equations reduces the first system of equations to a number of smaller subproblems (the second system of equations). Solutions to these smaller subproblems may then be obtained, and these solutions may then be used to reconstruct the solution to the initial problem (represented by the first system of equations).

Therefore, applying a method of cyclic reduction to the first system of equations to obtain a second system of equations reduces the computational complexity of the method 100 and/or enables a solution to the first system of equations to be obtained using parallel computing and/or quantum computing methods.

As noted above, the first system of equations represent each layer of the spatially discretized representation of the semiconductor device as being coupled to its adjacent layers. For example, for a spatially discretized representation of the semiconductor device that comprises 5 layers, the first system of equations may represent that: layer 1 is coupled to layer 2; layer 2 is coupled to layers 1 and 3; layer 3 is coupled to layers 2 and 4; layer 4 is coupled to layers 3 and 5; and layer 5 is coupled to layer 4.

In some embodiments, applying a method of cyclic reduction to the first system of equations decouples one or more of the layers of the spatially discretized representation of the semiconductor device, to obtain a second system of equations. That is, the second system of equations represents only some of the layers of the spatially discretized representation of the semiconductor device being coupled to one another.

For example, the second system of equations may represent a spatially discretized representation of the semiconductor device where only the first layer and the last layer of the spatially discretized representation of the semiconductor device are coupled to one another. For example, considering a spatially discretized representation of the semiconductor device that comprises 5 layers, the second system of equations may represent that: layer 1 is coupled to layer 5; and layer 5 is coupled to layer 1.

In other words, applying a method of cyclic reduction to a first system of equations, where the first system of equations represents each layer of the spatially discretized representation of the semiconductor device as being is coupled to its adjacent layers, allows a second system of equations to be obtained, where the second system of equations represents only some of the layers of the spatially discretized representation of the semiconductor device as being coupled to one another.

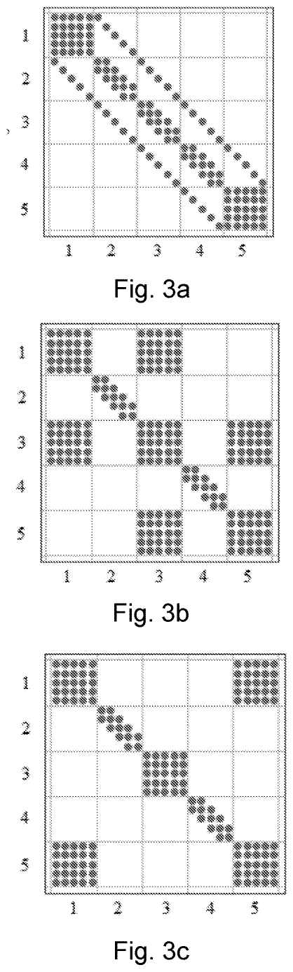

Examples of applying a method of cyclic reduction to the first system of equations to decouple one or more of the layers of the spatially discretized representation of the semiconductor device are described with reference to FIG. 3.

At step 108, the method 100 comprises determining a solution to the second system of equations.

For example, determining a solution to the second system of equations may comprise determining one or more entries of a solution vector of the first system of equations. The one or more entries of the solution vector correspond to the layers of the semiconductor device that are represented as coupled in the second system of equations.

At step 110, the method 100 comprises estimating the property of the semiconductor device based on the solution to the second system of equations.

For example, estimating the property of the semiconductor device based on the solution to the second system of equations may comprise reconstructing the remaining entries of the solution vector based on the determined one or more entries of a solution vector. In this example, the solution vector represents the property of the semiconductor device.

Examples of reconstructing the remaining entries of the solution vector based on the determined one or more entries of a solution vector are described with reference to FIG. 3.

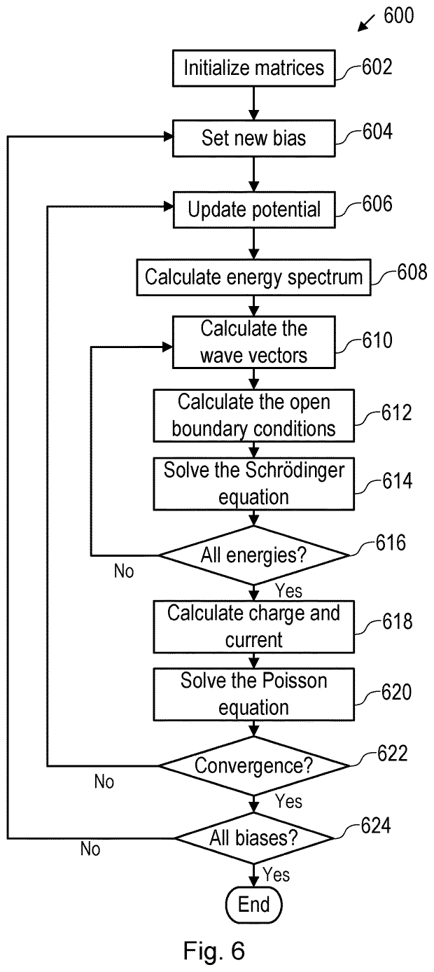

In some embodiments, the method 100 further comprises using the estimated property of the semiconductor device to estimate one or more further properties of the semiconductor device. For example, in embodiments in which the wave function of the semiconductor device is estimated, the obtained wave function may then be used to estimate the electrostatic potential in the semiconductor device (as described with reference to FIG. 6).

In some embodiments, the method 100 further comprises using the estimated one or more further properties of the semiconductor device to estimate one or more properties of a circuit including the semiconductor device. In some embodiments, the method 100 further comprises using the estimated property of the semiconductor device in a design process. For example, in some embodiments, using the estimated property of the semiconductor device in a design process may comprise adjusting a design of the semiconductor device and/or adjusting a circuit comprising the semiconductor device, based on the estimated property.

In some embodiments, the property of the semiconductor device is estimated in a method of simulating the semiconductor device and/or a circuit comprising the semiconductor device. That is, the method 100 may be used to estimate a property of the semiconductor device in a simulation method, for example, the method 600 described with reference to FIG. 6.

An example method of initializing a first system of equations (that is, an example implementation of step 104 of the method 100) is now described.

FIG. 2 illustrates an example of a spatially discretized representation of a semiconductor device 200, comprising plurality of layers 208a . . . 208e.

The spatially discretized representation of the semiconductor device 200 comprises leads 202 and 204, representing the source and drain contacts respectively.

The spatially discretized representation of the semiconductor device 200 comprises a plurality of nodal points (for example, the nodal point 206a, represented by the indices (1,1)), that are grouped to represent the layers 208a, 208b, 208c, 208d, 208e of the spatially discretized representation of the semiconductor device 200

In some embodiments described herein, the Schrödinger equation and/or the Poisson equation are solved for each layer comprised within the spatially discretized representation of the semiconductor device 200.

Considering the Schrödinger equation as an example, a two-dimensional Schrödinger equation for the spatially discretized representation of the semiconductor device may be expressed as the following first system of equations:

$$[ \begin{matrix}{H}_{1 , 1}^{d} + {\sum }_{L} - EI & {H}_{1 , 2}^{D} & 0 & … & 0 \\ {H}_{2 , 1}^{D} & {H}_{2 , 2}^{D} - EI & {H}_{2 , 3}^{D} & ⋱ & ⋮ \\ 0 & ⋱ & ⋱ & ⋱ & 0 \\ ⋮ & ⋱ & ⋱ & ⋱ & {H}_{{n}_{x} - 1 , {n}_{x}}^{D} \\ 0 & … & 0 & {H}_{{n}_{x} - 1 , {n}_{x}}^{D} & {H}_{{n}_{x} , {n}_{x}}^{D} + {\sum }_{R} - EI\end{matrix} ] [ \begin{matrix}{Φ}_{1} \\ {Φ}_{2} \\ ⋮ \\ ⋮ \\ {Φ}_{{N}_{X}}\end{matrix} ] = [ \begin{matrix}{b}_{1} \\ 0 \\ ⋮ \\ ⋮ \\ 0\end{matrix} ] \qquad ( 3 )$$

This two-dimensional Schrödinger equation for the spatially discretized representation of the semiconductor device is obtained using a rectangular mesh element and a “vertical” ordering, as described in greater detail below.

The elements in the matrices are in themselves matrices of size n_{z}×n_{z} corresponding to, for each of the layers 208a . . . 208e of the spatially discretized representation of the semiconductor device 200, the nodal points comprised within the layer. The matrices are obtained using the finite element method with uniform rectangular mesh elements.

The diagonal elements in equation 3 describe interactions within a layer of the spatially discretized representation of the semiconductor device 200, and off diagonal elements describe interactions between adjacent layers spatially discretized representation of the semiconductor device 200. In this example, diagonal elements in H have been denoted H_{i,i}(for example

$${H}_{1 , 1} = {H}_{1 , 1}^{D} + {\sum }_{L} - EI ) ,$$

and off-diagonal elements in H have been denoted H_{i,±i} (for example

$${H}_{1 , 2} = {H}_{1 , 2}^{D} ) .$$

The structure of equation 3 may be obtained from equation 1 as follows.

Excluding the open boundary conditions Σ_{L} and Σ_{R}, each row in H in equation 1 has at most five nonzero elements and it can be written in the following form

$${( H ϕ )}_{ij} = {a}_{ij} {u}_{ij} - {b}_{ij} {u}_{i - 1 j} - {c}_{ij} {u}_{i + 1 j} - {d}_{ij} {u}_{ij - 1} - {e}_{ij} {u}_{ij + 1} \qquad ( 4 )$$

where i=1, . . . , n_{z} and j=1, . . . , nₓ denote the 2D spacial position in the discretization (that is, denote the nodal point), aᵢⱼ describes on site energies at the respective nodal point, bᵢⱼ and cᵢⱼ describe interactions with neighbouring sites in the z-direction, and dᵢⱼ and eᵢⱼ describe interactions with neighbouring sites in the x-direction.

The 2-dimensional indices ij are then mapped to a 1-dimensional index i. The indices may be mapped in this manner using a number of different orderings (for example, using natural ordering, or using red-black ordering). It will be appreciated that using different mappings will give different structures to the matrix H in equation 3.

In this illustrated example, the following ordering is employed.

$$l ( i , j ) = i + ( j - 1 ) \cdot {n}_{z} \qquad ( 5 )$$

This mapping enables equation 1 to be written in the block tri-diagonal form shown in equation 3, and enables a method of block cyclic reduction to be performed on the resulting block tri-diagonal matrix.

As noted above, this ordering is a vertical ordering that maps, over each layer of the semiconductor device at a time, from the top to the bottom of the layer.

This ordering gives the following structure to the H matrix. Considering an arbitrary row r(I, j)

$${H}_{r} = [ \vec{0} - {d}_{r} \vec{0} - {b}_{r} {a}_{r} - {c}_{r} \vec{0} {e}_{r} \vec{0} ] \qquad ( 6 )$$

Where the column indices corresponding to −dᵣ, −bᵣ, aᵣ, and eᵣ are r−n_{z}, r−1, r, r+1 and r+n_{z} respectively. In a matrix format, and neglecting any open-boundary conditions, this arbitrary row can be written as:

$$[ \begin{matrix}{a}_{1} & - {c}_{1} & 0 & … & 0 & - {e}_{1} & 0 & … & 0 \\ - {b}_{2} & {a}_{2} & - {c}_{2} & 0 & … & 0 & - {e}_{2} & ⋱ & ⋮ \\ 0 & ⋱ & ⋱ & ⋱ & 0 & … & 0 & ⋱ & \\ ⋮ & ⋱ & - {b}_{{n}_{z}} & {a}_{{n}_{z}} & 0 & ⋱ & & ⋱ & \\ - {d}_{{n}_{z} + 1} & 0 & & 0 & {a}_{{n}_{z} + 1} & - {c}_{{n}_{z} + 1} & & & \\ 0 & ⋱ & ⋱ & & ⋱ & ⋱ & & & \\ ⋮ & ⋱ & - {d}_{n - 2} & … & 0 & - {b}_{n - 2} & {a}_{n - 2} & - {c}_{n - 2} & 0 \\ ⋮ & & & - {d}_{n - 1} & … & 0 & - {b}_{n - 1} & {a}_{n - 1} & - {c}_{n - 1} \\ 0 & … & & 0 & - {d}_{n} & … & 0 & - {b}_{n} & {a}_{n}\end{matrix} ] \qquad ( 7 )$$

This matrix is block-tridiagonal, and can be written as shown in equation 3.

The block matrices illustrated in equation 3 will therefore have the following structure:

$${H}_{r , r}^{D} = [ \begin{matrix}{a}_{1 + ( r - 1 ) {n}_{z}} & - {c}_{1 + ( r - 1 ) {n}_{z}} & 0 & 0 & … & 0 \\ - {b}_{2 + ( r - 1 ) {n}_{z}} & {a}_{2 + ( r - 1 ) {n}_{z}} & - {c}_{2 + ( r - 1 ) {n}_{z}} & 0 & ⋱ & ⋮ \\ 0 & - {b}_{2 + ( r - 1 ) {n}_{z}} & {a}_{2 + ( r - 1 ) {n}_{z}} & - {c}_{2 + ( r - 1 ) {n}_{z}} & 0 & ⋱ \\ ⋮ & ⋱ & ⋱ & ⋱ & ⋱ & ⋱ \\ 0 & … & 0 & - {b}_{{rn}_{z - 1}} & {a}_{{rn}_{z - 1}} & - {c}_{{rn}_{z - 1}} \\ 0 & … & & 0 & - {b}_{{rn}_{z}} & {a}_{{rn}_{z}}\end{matrix} ] \qquad ( 8 )$$

$${H}_{r , r - 1}^{D} = [ \begin{matrix}- {d}_{1 + ( r - 1 ) {n}_{z}} & 0 & … & & 0 \\ 0 & - {d}_{2 + ( r - 1 ) {n}_{z}} & 0 & … & 0 \\ ⋮ & ⋱ & ⋱ & ⋱ & ⋮ \\ 0 & … & 0 & - {d}_{{rn}_{z - 1}} & 0 \\ 0 & … & & 0 & - {d}_{{rn}_{z}}\end{matrix} ] \qquad ( 9 )$$

$${H}_{r , r + 1}^{D} = [ \begin{matrix}- {e}_{1 + ( r - 1 ) {n}_{z}} & 0 & … & & 0 \\ 0 & - {e}_{2 + ( r - 1 ) {n}_{z}} & 0 & … & 0 \\ ⋮ & ⋱ & ⋱ & ⋱ & ⋮ \\ 0 & … & 0 & - {e}_{{rn}_{z - 1}} & 0 \\ 0 & … & & 0 & - {e}_{{rn}_{z}}\end{matrix} ] \qquad ( 10 )$$

The system of equations is then initialized as follows.

The values of the matrix elements are calculated using linear shape functions in the finite element method. The open boundary conditions, Σ_{L} and Σ_{R}, are also n_{z}×n_{z} matrices which are calculated from the QTBM.

As the wave-function of the semiconductor device is vanishing outside the semiconductor device, there is a 0-value Dirichlet boundary condition on the Γₒ boundary (that is, the boundary of the semiconductor device that is not in contact with any of the leads). To enforce this boundary condition, the rows r corresponding to the boundary can be set to zero, with the exception of the diagonal elements, which are set to 1. The injection vector B^{m} will be zero everywhere except for the indices that pertain to the device-lead boundary. This procedure leads to the insertion of the trivial equation 1·Φᵣ=0 into the system at every boundary index. However, these trivial equations are removed before solving the system of equations to avoid unnecessary computations and keep the matrix structure H as shown in equation 3.

An example method of applying a method of cyclic reduction to a first system of equations to obtain a second system of equations is now described with reference to FIG. 3. That is, an example implementation of step 106 of the method 100 is now described with reference to FIG. 3.

In this example, the method of cyclic reduction is applied to the first system of equations as shown in equation 3.

FIG. 3a illustrates the matrix structure of the matrix H of equation 3. FIG. 3b illustrates a matrix structure of the matrix H obtained following the execution of a first stage of a BCR method. FIG. 3c illustrates the matrix structure of the matrix H obtained following the execution of a second stage of a BCR method. For each of FIGS. 3a-3c, non-zero matrix elements are indicated with dots.

In the first stage of the BCR method, layer 2 of the semiconductor device is decoupled as follows.

As layers 1 and 3 are the layers of the semiconductor device that layer 2 is presently coupled to, the blocks H_{1,1}, H_{3,3}, H_{3,1} and H_{1,3} are “renormalized” as follows:

$$\begin{matrix}{X}_{2} = {H}_{2 , 2}^{- 1} {H}_{2 , 1} \\ {Y}_{2} = {H}_{2 , 2}^{- 1} {H}_{2 , 3} \\ {\hat{H}}_{1 , 1} = {H}_{1 , 1} - {H}_{1 , 2} {X}_{2} \\ {\hat{H}}_{3 , 3} = {H}_{3 , 3} - {H}_{3 , 2} {Y}_{2} \\ {\hat{H}}_{1 , 3} = {H}_{1 , 2} {Y}_{2} \\ {\hat{H}}_{3 , 1} = {\hat{H}}_{1 , 3}^{†}\end{matrix}$$

Layer 4 of the semiconductor device is also decoupled in the first stage as follows.

As layers 3 and 5 are the layers of the semiconductor device that layer 4 is presently coupled to, the blocks H_{3,3}, H_{5,5} and H_{5,3} and H_{3,5} are “renormalized” as follows:

$$\begin{matrix}{X}_{4} = {H}_{4 , 4}^{- 1} {H}_{4 , 3} \\ {Y}_{4} = {H}_{4 , 4}^{- 1} {H}_{4 , 5} \\ {\hat{H}}_{3 , 3} = {H}_{3 , 3} - {H}_{3 , 4} {X}_{4} \\ {\hat{H}}_{5 , 5} = {H}_{5 , 5} - {H}_{5 , 4} {Y}_{4} \\ {\hat{H}}_{3 , 5} = {H}_{3 , 4} {Y}_{4} \\ {\hat{H}}_{5 , 3} = {\hat{H}}_{3 , 5}^{†}\end{matrix}$$

Therefore, in some embodiments, applying a method of cyclic reduction to the first system of equations to obtain a second system of equations comprises:
for one or more layers of the spatially discretized representation:
   for layer i, where layer i is coupled to layer i−l and layer i+r:
      renormalizing the matrix blocks H_{i-l,i}, H_{i+r,i}, H_{i,i-l} and H_{i,i+r} of the first system of equations.

In some embodiments, the step of renormalizing the matrix blocks H_{i-l,i}, H_{i+r,i}, H_{i,i-l} and H_{i,i+r} comprises:
determining the inverse matrix of the matrix block H_{i,i}; and
renormalizing the matrix blocks H_{i-l,i}, H_{i+r,i}, H_{i,i-l} and H_{i,i+r} based on the determined one or more inverse matrices.

In this example, following the execution of the first stage of the BCR method, a system of equations is obtained (as shown in FIG. 3b) that represents layers 1, 3 and 5 of the semiconductor device as being coupled to one another. In other words, following the execution of the first stage of the BCR method, layers 2 and 4 of the semiconductor device are decoupled from the other layers of the semiconductor device.

In this embodiment, the first stage only deals with the inversion of sparse tridiagonal matrices. As it is easier to invert a sparse matrix than a full matrix, (which are introduced in the other decoupling stages, as shown in FIG. 3b (that is decoupling a layer will introduce full matrices in the layers that the decoupled layer was previously coupled to), it is desirable to decouple as many layers as possible in the first stage.

Therefore, in some embodiments, renormalizing the matrix blocks for the one or more layers is performed first for one or more evenly indexed layers of the one or more layers of the spatially discretized representation. This step may be performed in parallel for each of the one or more evenly indexed layers, as these layers are not connected to one another.

In the second stage of the BCR method, layer 3 of the semiconductor device is decoupled as follows.

As layers 1 and 5 are the layers of the semiconductor device that layer 3 is presently coupled to, the blocks H_{1,1}, H_{5,5}, H_{5,1} and H_{1,5} are “renormalized” as follows:

$$\begin{matrix}{X}_{3} = {H}_{3 , 3}^{- 1} {H}_{3 , 1} \\ {Y}_{3} = {H}_{3 , 3}^{- 1} {H}_{3 , 5} \\ {\hat{H}}_{1 , 1} = {H}_{1 , 1} - {H}_{1 , 3} {X}_{3} \\ {\hat{H}}_{5 , 5} = {H}_{5 , 5} - {H}_{5 , 3} {Y}_{3} \\ {\hat{H}}_{1 , 5} = {H}_{1 , 3} {Y}_{3} \\ {\hat{H}}_{5 , 1} = {\hat{H}}_{1 , 5}^{†}\end{matrix}$$

In some embodiments, after renormalizing the matrix blocks for the one or more evenly indexed layers, renormalizing the matrix blocks for half of oddly indexed layers of the one or more layers of the spatially discretized representation. This step may be performed in parallel for each of the half of oddly indexed layers, as these layers are not connected to one another.

In some embodiments, comprising renormalizing the matrix blocks for remaining layers of the one or more layers of the spatially discretized representation. That is, although stage 2 of FIG. 3 is the final stage of the BCR method described with reference to FIG. 3, for a semiconductor device comprising more layers, a BCR may comprise a third stage. It is noted that this step cannot be performed in parallel for the remaining layers, as the remaining layers are connected to one another.

In this example, following the execution of the second stage of the BCR method, a second system of equations is obtained (as shown in FIG. 3c) that represents only layer 1 and 5 of the semiconductor device as being coupled to one another. In other words, following the execution of the second stage of the BCR method, layer 3 of the semiconductor device is decoupled from the other layers of the semiconductor device.

Therefore, in some embodiments, the one or more layers of the spatially discretized representation comprises all layers except layer 1 and layer nₓ of the spatially discretized representation.

In some embodiments, determining the one or more inverse matrices comprises determining the one or more inverse matrices according to the method 400, or the method 500, described below.

In this illustrated embodiment, the first and last layers are not decoupled. It is noted that the first and last matrix blocks of FIG. 3a are the only blocks that are full and complex, due to the open boundary conditions. Therefore, decoupling the first and last layers in an earlier stage of the BCR method would introduce complex numbers in the decoupling process. Complex arithmetic is 4 times slower than real arithmetic. Therefore, by not decoupling the first and last layers, no complex arithmetic is introduced into the BCR method, therefore decreasing the execution time of the method.

It is also noted that one of the first layer or last layer will have a nonzero injection vector, and should not be decoupled for this reason.

Considering equation 3, one difference between the method of block cyclic reduction described in [9], and the method of block cyclic reduction described with reference to FIG. 3, is that the methods of block cyclic reduction are applied to matrices of different structures.

In [9], the matrix which the method of block cyclic reduction is applied to comprises diagonal matrix blocks, where each of these matrix blocks are then also diagonal (an example of this structure is illustrated in FIG. 1 of [10]). This matrix structure arises as the matrix of [9] does not comprise any elements that represent connections between sites (nodal points) in each layer of the semiconductor device.

Therefore, in [9], the Xᵢ and Yᵢ matrices can be computed trivially, as they only require the inverse of diagonal matrices to be computed.

In contrast, for a rectangular mesh discretized Schrödinger equation (such as equation 3), the BCR method is applied to a sparse linear system, where the diagonal matrix blocks are not diagonal, and therefore, executing the BCR method requires the calculation of computationally intensive matrix inverses.

As illustrated in FIG. 3a, the execution of the first step of the BCR method described herein requires the computation of inverses of tridiagonal matrices. It is also noted that, for the BCR method described herein, full matrices are introduced in the computation in all stages of the BCR method. In [9], matrices are only introduced in the computation in the final stage of the BCR method.

As noted above, following the execution of the second stage of the BCR method described herein, a 2n_{z}×2n_{z} linear system of equations is obtained.

The 2n_{z}×2n_{z} linear system of equations can then be solved to determine the entries Φ₁ and Φₙ_{ₓ} of the solution vector Φ. In this example, the 2n_{z}×2n_{z} linear system of equations shown in FIG. 3c can be solved to obtain entries 1 and 5 of the solution vector.

The rest of the solution vector Φ can then reconstructed using the following equation, for each entry Φᵢ:

$${Φ}_{i} = - {X}_{i} {Φ}_{i - l} - {Y}_{i} {Φ}_{i + r} \qquad ( 2 g )$$

Where Φᵢ₋ₗ and Φᵢ₊ᵣ are the entries of the solution vector corresponding to the layers that layer i was previously coupled to prior to layer i being decoupled. That is, the entry Φᵢ is reconstructed based on the layers that layer i was coupled to prior to the decoupling of the layer. For this example, entry 3 of the solution vector will be reconstructed based on entries 1 and 5 of the solution vector, entry 2 of the solution vector will be reconstructed based on entries 1 and 3 of the solution vector, and entry 4 of the solution vector will be reconstructed based on entries 3 and 5 of the solution vector.

Therefore, in some embodiments, determining a solution to the second system of equations comprises:
solving the second system of equations to obtain entry i=1 of a solution vector, and entry i=nₓ of the solution vector, where the first system of equations comprises the solution vector.

Therefore, in some embodiments, determining a solution to the second system of equations comprises further comprises reconstructing the remaining entries of the solution vector other than entries 1 and nₓ.

However, it is noted that, in the reconstruction stage of BCR method, it is not possible to reconstruct a nonzero solution if the solutions in first and last layer of the semiconductor device, Φ₁ and Φₙ_{_{X}} (that is, the two layers that the re-coupling stage starts from), are equal to zero. It is also noted that the accuracy of the BCR method can be affected if solutions in first and last layer of the semiconductor device, Φ₁ and Φₙ_{ₓ} are much smaller than the rest of the solution (that the recoupling stage aims to reconstruct).

Certain embodiments herein attempt to overcome these problems by utilizing a BCR method that obtains a second system of equations that represents the first, the last, and one additional layer of the semiconductor device as being coupled.

In other words, certain embodiments herein utilize a BCR method that keeps an additional layer of the semiconductor device in the decoupling stage.

In some embodiments, the additional layer is selected based on the likelihood that the solution for the additional layer will be similar in magnitude to the solution for the semiconductor device. As the solution for the device can then be reconstructed based on the solution for this additional layer, this improves the accuracy of the solution obtained for the device. Therefore, in some embodiments, the method 100 further comprises selecting a further layer of the spatially discretized representation.

In some embodiments, the additional layer is selected from the final decoupling stage of the BCR method. For example, considering the example shown in FIG. 3, if layer 3 was selected as the additional layer, stage 1 would become the final stage of the BCR method.

Therefore, in some embodiments, determining a solution to the second system of equations comprises:
solving the second system of equations to obtain entry i=1 of a solution vector, entry i=nₓ of the solution vector, and the entry of the solution vector with an index corresponding to the index of the further layer, where the first system of equations comprises the solution vector.

Therefore, in some embodiments, determining a solution to the second system of equations further comprises reconstructing the remaining entries of the solution vector other than entries 1 and nₓ, and the entry of the solution vector with an index corresponding to the index of the further layer.

In embodiments in which the first system of equations comprises a two-dimensional Schrödinger equation for the spatially discretized representation of the semiconductor device, the additional layer may be selected based on the magnitude of the wave function in the additional layer of the semiconductor device. For example, the additional layer may be selected such that: the magnitude of the wave function of the additional layer is not negligible, the magnitude of the wave function of the additional layer corresponds to the magnitude of the wave function of the semiconductor device, the wave function of the additional layer belongs to the modes of the wave function of the semiconductor device, and the magnitude of the wave function of the additional layer corresponds to the magnitude of one of modes of the wave function of the semiconductor device.

Therefore, in some embodiments, the step of selecting the further layer comprises selecting the further layer based on:
a magnitude of a wave function of the spatially discretized representation of the semiconductor device, and
a magnitude of a wave function of the further layer.

It is noted that, for embodiments in which an additional layer is kept in the decoupling stage, executing the final stage of the BCR method results in a 3n_{z}×3n_{z} linear system of equations being obtained, which can then be solved to determine the entries of the solution vector corresponding to the first, last and additional layer of the semiconductor device.

As noted above, the most time consuming part of the BCR method is the inversion of the diagonal blocks.

A quantum method is now described, that attempts to accelerate the computation of an inverse of a matrix.

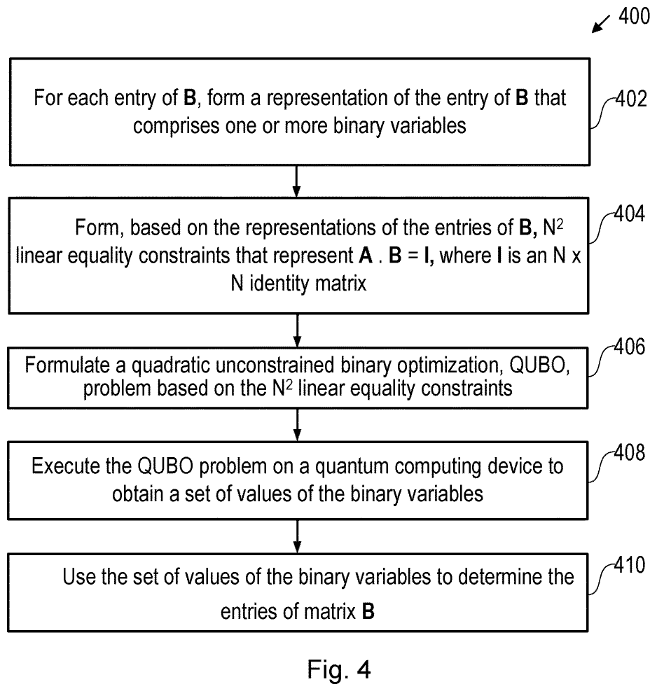

FIG. 4 illustrates a method 400 of determining entries of a N×N matrix B, where the matrix B is the inverse of a N×N matrix A. The method 400 may be used to determining the one or more inverse matrices in accordance with the method described with reference to FIG. 3 above (that is, in accordance with a method of implementing step 106 of the method 100).

In some embodiments, the method 400 utilizes an objective function based on the following expression (as will be explained in greater detail below):

$$‖ A \cdot B - I ‖$$

where I is the identity matrix.

This expression may be written as follows:

$$A \cdot B = I = [ \begin{matrix}{a}_{11} & … & {a}_{1 N} \\ ⋮ & ⋱ & ⋮ \\ {a}_{N 1} & … & {a}_{NN}\end{matrix} ] [ \begin{matrix}{b}_{11} & … & {b}_{1 N} \\ ⋮ & ⋱ & ⋮ \\ {b}_{N 1} & … & {b}_{NN}\end{matrix} ] = [ \begin{matrix}1 & … & 0 \\ ⋮ & ⋱ & ⋮ \\ 1 & … & 1\end{matrix} ] \qquad ( 11 a )$$

At step 402, the method 400 comprises, for each entry of B, forming a representation of the entry of B that comprises one or more binary variables. That is, the method 400 utilizes a binary representation of many unknowns. For an accuracy of R qubits, the quantum computing device requires R·N² logical qubits to represent the R·N² binary variables.

For example, in some embodiments, each representation of each entry of B, bᵢⱼ, may comprises R binary variables

$${q}_{ij}^{k}$$

as follows:

$${b}_{ij} = {c}_{ij} {\sum }_{k = 0}^{R - 1} {2}^{- k} {q}_{ij}^{k} - {d}_{ij} ∈ [ - {d}_{ij} , 2 {c}_{ij} - {d}_{ij} ) \qquad ( 11 b )$$

In these embodiments, equation 11a may then be expressed as follows:

$$( 11 C )$$

$$A \cdot B = I = [ \begin{matrix}{a}_{11} & … & {a}_{1 N} \\ ⋮ & ⋱ & ⋮ \\ {a}_{N 1} & … & {a}_{NN}\end{matrix} ] [ \text{} \begin{matrix}{c}_{11} {\sum }_{k = 0}^{R - 1} {2}^{- k} {q}_{11}^{k} - {d}_{11} & … & {c}_{1 N} {\sum }_{k = 0}^{R - 1} {2}^{- k} {q}_{1 N}^{k} - {d}_{1 N} \\ ⋮ & ⋱ & ⋮ \\ {c}_{N 1} {\sum }_{k = 0}^{R - 1} {2}^{- k} {q}_{N 1}^{k} - {d}_{N 1} & … & {c}_{NN} {\sum }_{k = 0}^{R - 1} {2}^{- k} {q}_{NN}^{k} - {d}_{NN}\end{matrix} ] = \text{}$$

$$[ \begin{matrix}1 & … & 0 \\ ⋮ & ⋱ & ⋮ \\ 0 & … & 1\end{matrix} ] = \text{} [ \begin{matrix}\begin{matrix}\begin{matrix}{\sum }_{j = 1}^{N} {a}_{1 j} {c}_{j 1} \\ {\sum }_{k = 0}^{R - 1} {2}^{- k} {q}_{j 1}^{k} -\end{matrix} \\ {a}_{1 j} {d}_{j 1}\end{matrix} & … & \begin{matrix}\begin{matrix}{\sum }_{j = 1}^{N} {a}_{1 j} {c}_{j N} \\ {\sum }_{k = 0}^{R - 1} {2}^{- k} {q}_{j N}^{k} -\end{matrix} \\ {a}_{1 j} {d}_{j N}\end{matrix} \\ ⋮ & ⋱ & ⋮ \\ \begin{matrix}\begin{matrix}{\sum }_{j = 1}^{N} {a}_{N j} {c}_{j 1} \\ {\sum }_{k = 0}^{R - 1} {2}^{- k} {q}_{j 1}^{k} -\end{matrix} \\ {a}_{N j} {d}_{j 1}\end{matrix} & … & \begin{matrix}\begin{matrix}{\sum }_{j = 1}^{N} {a}_{N j} {c}_{j N} \\ {\sum }_{k = 0}^{R - 1} {2}^{- k} {q}_{j N}^{k} -\end{matrix} \\ {a}_{N j} {d}_{j N}\end{matrix}\end{matrix} ] = [ \begin{matrix}1 & … & 0 \\ ⋮ & ⋱ & ⋮ \\ 0 & … & 1\end{matrix} ]$$

Binary expansion of unknown value (in this case, b) requires a domain [−d, 2c−d) to be specified. The smaller the domain, the more accurate solution obtained with a smaller number of qubits. A very large domain could be specified, at the sacrifice of the accuracy of the solution. However, based on the obtained solution, a new, smaller domain can be specified around the obtained solution. A new, more accurate, solution can then be computed with this new domain. Determining solutions in this iterative manner may therefore enable a satisfactory solution to be obtained.

In some embodiments, the entries of the matrix A represent interactions within a layer of a spatially discretized representation of a semiconductor device. For example, A may comprises a matrix block H_{i,i} of equation 3.

At step 404, the method 400 comprises forming, based on the representations of the entries of B, N² linear equality constraints that represent A·B=I, where I is an N×N identity matrix.

For example, in some embodiments, equation 11c may be expressed as N² linear equality constraints as follows

$$\begin{matrix}{\sum }_{j = 1}^{N} {a}_{1 j} {c}_{j 1} {\sum }_{k = 0}^{R - 1} {2}^{- k} {q}_{j 1}^{k} = 1 + {a}_{1 j} {d}_{j 1} \\ {\sum }_{j = 1}^{N} {a}_{1 j} {c}_{jN} {\sum }_{k = 0}^{R - 1} {2}^{- k} {q}_{jN}^{k} = {a}_{1 j} {d}_{jN} \\ ⋮ \\ {\sum }_{j = 1}^{N} {a}_{Nj} {c}_{j 1} {\sum }_{k = 0}^{R - 1} {2}^{- k} {q}_{j 1}^{k} = {a}_{Nj} {d}_{j 1} \\ ⋮ \\ {\sum }_{j = 1}^{N} {a}_{Nj} {c}_{j 1} {\sum }_{k = 0}^{R - 1} {2}^{- k} {q}_{j 1}^{k} = 1 + {a}_{Nj} {d}_{j 1}\end{matrix}$$

At step 406, the method 400 comprises formulating a quadratic unconstrained binary optimization, QUBO, problem based on the N² linear equality constraints.

In some embodiments, formulating a quadratic unconstrained binary optimization, QUBO, problem based on the N² linear equality constraints comprises expressing the N² linear equality constraints in the form Cx=b, where x is a binary decision vector comprising the binary variables.

For example, in some embodiments, the aforementioned N² constraints can be expressed in the form Cx=b, where C is matrix of size N×R·N, and x is a binary decision vector of size R·N², as follows:

$$( 12 )$$

$$[ \begin{matrix}{\sum }_{j = 1}^{N} {a}_{1 j} {c}_{j 1} {\sum }_{k = 0}^{R - 1} {2}^{- k} & 0 & … & … & … & … & 0 \\ 0 & ⋱ & 0 & … & … & … & 0 \\ ⋮ & 0 & {\sum }_{j = 1}^{N} {a}_{N j} {c}_{j N} {\sum }_{k = 0}^{R - 1} {2}^{- k} & 0 & … & … & 0 \\ ⋮ & ⋮ & 0 & ⋱ & 0 & … & 0 \\ ⋮ & ⋮ & ⋮ & 0 & {\sum }_{j = 1}^{N} {a}_{N j} {c}_{j N} {\sum }_{k = 0}^{R - 1} {2}^{- k} & 0 & 0 \\ ⋮ & ⋮ & ⋮ & ⋮ & 0 & ⋱ & 0 \\ 0 & … & … & … & … & 0 & {\sum }_{j = 1}^{N} {a}_{N j} {c}_{j 1} {\sum }_{k = 0}^{R - 1} {2}^{- k} {q}_{j 1}^{k}\end{matrix} ] [ \begin{matrix}{q}_{j 1}^{k} \\ ⋮ \\ {q}_{N}^{k} \\ ⋮ \\ {q}_{j 1}^{k} \\ ⋮ \\ {q}_{jN}^{k}\end{matrix} ] = [ \begin{matrix}1 + {a}_{1 j} {d}_{j 1} \\ ⋮ \\ {a}_{1 j} {d}_{jN} \\ ⋮ \\ {a}_{Nj} {d}_{j 1} \\ ⋮ \\ 1 + {a}_{Nj} {d}_{j 1}\end{matrix} ]$$

In some embodiments formulating the QUBO problem based on the N² linear equality constraints further comprises:
formulating a QUBO matrix, Q, such that Q=C^{T}C−2b^{T}C.

For example, in some embodiments, the QUBO matrix may be obtained as follows:

$$\begin{matrix}E = {( Cx - b )}^{2} \\ = {x}^{T} {C}^{T} Cx + {b}^{T} b - 2 {b}^{T} Cx\end{matrix}$$

As b^{T}b is same for all combinations, it can be ignored, such that:

$$E \approx {x}^{T} {C}^{T} Cx - 2 {b}^{T} Cx$$

When x∈{0,1}x²=x, then b^{T}Cx=X^{T}b^{T}Cx:

$$\begin{matrix}E \approx {x}^{T} [ {C}^{T} C ] x - {x}^{T} 2 {b}^{T} Cx \\ E \approx {x}^{T} [ {C}^{T} C - 2 {b}^{T} C ] x\end{matrix}$$

Thus, the QUBO is formulated as:

$$Q = {C}^{T} C - 2 {b}^{T} C \qquad ( 13 )$$

That is, in some embodiments, a QUBO formulation to compute a matrix inverse B using a quantum annealing process is obtained by converting the direct sum of the linear system A·Bᵢ=ûᵢ, corresponding to each unit vector ûᵢ of identity matrix I=A·B and the associated unknown column vector Bᵢ of the inverse matrix B, into a block diagonal linear system Cx=b, and computing the difference between the product of transpose of block diagonal matrix C with C and the product of transpose of b with C.

At step 408, the method 400 comprises executing the QUBO problem on a quantum computing device to obtain a set of values of the binary variables.

In some embodiments, executing the QUBO problem on the quantum computing device to obtain values of the binary variables comprises:
manipulating quantum states of qubits of the quantum computing device based on the QUBO matrix, Q;
obtaining a measurement of each of the one or more qubits; and
based on the obtained measurements, determining the set of values of the binary variables.

In some embodiments, the measured state of the qubits of the quantum computing device corresponds to a solution of the binary decision vector x.

In some embodiments, executing the QUBO problem on the quantum computing device comprises performing a quantum annealing process. In other embodiments, executing the QUBO problem on the quantum computing device may comprise executing a Quantum Approximate Optimization Algorithm on a Gate Model Quantum Computer.

At step 410, the method 400 comprises using the set of values of the binary variables to determine the entries of matrix B.

For example, in some embodiments, the determined set of values of the binary variables are used to reconstruct the entries of the matrix B, based on the formed representations of the entries of B.

Therefore, the method 400 is able to compute the inverse of the matrix A by embedding the aforementioned QUBO problem on a quantum computing device, and executing an annealing process once. In contrast, the method described in [11] requires the annealing and embedding process be executed N times, to determine the inverse of the matrix A. The method 400 is therefore approximately three times faster than the prior art approach.

In some embodiments, the method 400 is for use in a method of estimating a property of a semiconductor device, such as the method 100 described above. In some embodiments, the property comprises a wave function in the semiconductor device. In some embodiments, the property comprises an electrostatic potential in the semiconductor device.

In some embodiments, the method 400 is for use in a method of simulating a semiconductor device and/or a circuit comprising the semiconductor device. For example, the method 400 may be used in the method 600 of simulating a semiconductor device described below.

In some embodiments, the method 400 is performed on a data processing apparatus.

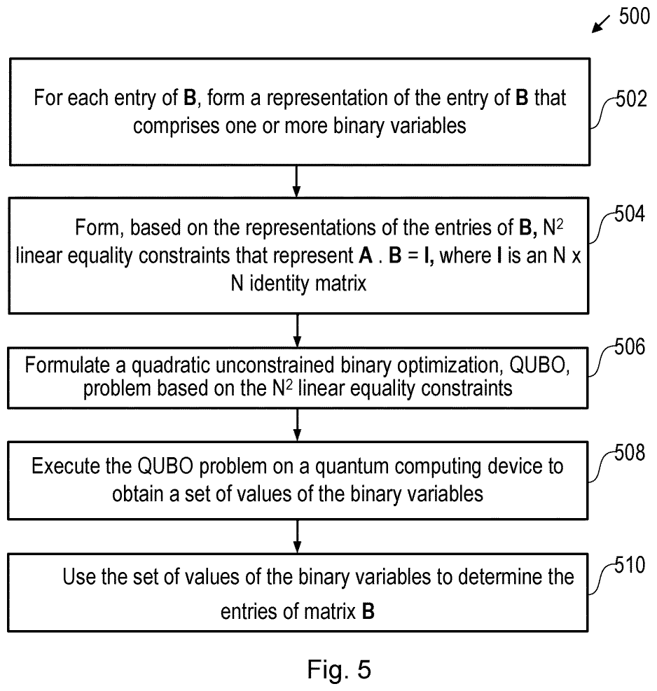

FIG. 5 illustrates a method 500, performed on a data processing apparatus, of determining entries of a N×N matrix B for use in a method of estimating a property of a semiconductor device, where the matrix B is the inverse of a N×N matrix A, and where the entries of the matrix A represent interactions between coupled layers of a spatially discretized representation of the semiconductor device. The method 500 is an example implementation of the method 400 described above.

At step 502, the method 500 comprises, for each entry of B, forming a representation of the entry of B that comprises one or more binary variables.

At step 504, the method 500 comprises, forming, based on the representations of the entries of B, N² linear equality constraints that represent A·B=I, where I is an N×N identity matrix.

At step 506, the method 500 comprises formulating a quadratic unconstrained binary optimization, QUBO, problem based on the N² linear equality constraints.

At step 508, the method 500 comprises executing the QUBO problem on a quantum computing device to obtain a set of values of the binary variables.

At step 510, the method 500 comprises using the set of values of the binary variables to determine the entries of matrix B.

Therefore, in some embodiments, a wave function of a semiconductor device may be estimated utilizing the methods of “Quantum Accelerated Block Cyclic Reduction” described herein (that is, utilizing the method 100 in combination with the method 400 or 500). The estimated wave function(s) may then be used to estimate steady-state properties (for example, current-voltage characteristics, charge density, current density) of a 2D nanoscale semiconductor device, as described with reference to FIG. 6.

FIG. 6 illustrates a method 600 of simulating a semiconductor device. The method 600 may utilize the method 100 described above to estimate a property of a semiconductor device, and may utilize the methods 400 and 500 to determine entries of a N×N matrix B, where the matrix B is the inverse of a N×N matrix A.

In this embodiment, simulations are performed in the 2D x(transport)-z(confinement) plane of the semiconductor device with the effective-mass approximation, limiting calculations to the first conduction band of Si, and approximating the (conduction) band minima with six equivalent ellipsoidal valleys. Translational minima are assumed in the y-direction (out-of-plane), as this embodiment relates to a wide device. Ballistic transport is also assumed for simplicity, and therefore no scattering is considered.

Ballistic transport may be considered a “best case” analysis of semiconductor device behavior.

In this embodiment, the Schrödinger equation and Poisson equation are solved self-consistently to determine the electrical behavior of the device. Executing the method 600 therefore enables one or more properties of the semiconductor device to be estimated (for example, charge distribution, current, wave function(s), electrostatic potential distribution). The numerical scheme employed in this embodiment comprises certain features described in [6,7].

At step 602, the method 600 comprises initializing the matrices for a Schrödinger equation discretized for the semiconductor device, and for a Poisson equation discretized for the semiconductor device.

At step 604, the method 600 comprises setting a new bias for the semiconductor device, and at step 606, the method 600 comprises updating the potential for the semiconductor device. For the first execution of the method, an initial potential distribution is used at step 606.

To determine current vs voltage (I-V) curves, the method 600 needs to be executed multiple times to determine the resulting current for many applied biases.

This process can be sped up through parallelization, allowing the resulting current from different bias points to be computed simultaneously.

At step 608, the method 600 comprises calculating the energy spectrum for the semiconductor device. It is noted that the energies

$${E}_{β}^{v}$$

are a continuous energy spectrum, and in this embodiment, are discretized in step 608. In this embodiment, the energies

$${E}_{β}^{v}$$

are discretized according to the approach outlined in [7].

In this embodiment, the energy spectrum is sampled by imposing two different closed boundary conditions of the Schrödinger equation (either zero-value Dirichlet or Neumann boundary conditions) on the device-lead interfaces, thus double sampling the spectrum. The two resulting eigenvalue problems are solved, and the eigenvalues from the solutions make up the energy sampling of the injection energies

$${E}_{β}^{v}$$

of the open system. This spectrum improves the accuracy of the obtained density of states [6]. The eigenfunctions from the eigenvalue problem will have “cosinelike” or “sinelike” behaviour at the Γₛ boundaries, form a complete orthogonal basis set that spans the Hilbert space of physical solutions in the device, and obey the injecting boundary conditions of the open system in equilibrium. These properties are then utilized when calculating the vector of injection modes B^{m} [6].

At step 610, the method 600 comprises calculating the wave vectors for the semiconductor device. In this embodiment, using the equations described in [7], the mode energies Eₘ are obtained considering an infinite-well. The mode energies in turn are used to compute the wave vectors

$${E}_{m}^{i}$$

(for mode “m” in lead i).

At step 612, the method 600 comprises calculating the open boundary conditions for the semiconductor device. For example, the open boundary conditions may be determined with the QTBM.

At step 614, the method 600 comprises solving a discretized Schrödinger equation for the semiconductor device, to obtain the wave function of the semiconductor device. In some embodiments, step 614 may comprise executing the method 600 to estimate the wave function of the semiconductor device. That is, the wave function in the semiconductor device may be obtained by solving the 2-dimensional Schrödinger equation for the discretized semiconductor device using a Block Cyclic Reduction method operative with individual layers.

At step 616, the method 600 comprises determining whether the discretized Schrödinger equation for the semiconductor device has been solved for all energies. If the discretized Schrödinger equation for the semiconductor device has been solved for all energies, the method 600 proceeds to step 618, else, the method returns to step 610.

Therefore, using the discretized energy spectrum obtained as described above, the wave functions φ for the open system containing the density of states (DOS) information can be obtained.

At step 618, the method 600 comprises calculating the charge distribution and the current for the semiconductor device. The charge distribution may be calculated using the equations provided in [6]. The current may be calculated using the equations provided in [7].

In this embodiment, following the determination of the wave functions φ for the open system containing the density of states (DOS) information, electron density n(x, z) and hole charge distribution p(x, z) may be determined according to the equations provided in [6].

At step 620, the method 600 comprises solving a discretized Poisson equation for the semiconductor device, to obtain an electrostatic potential distribution in the semiconductor device.

In this embodiment, following the determination of the distribution of electrons, holes and ionized dopants (that is, the distribution of all charge carriers), the Poisson equation is solved to find the electrostatic potential distribution in the 2D (x,z) cross section of the device, V, given by:

$$∇ \cdot [ ϵ ( x , z ) ∇ V ( x , z ) ] = e [ p ( x , z ) - n ( x , z ) + {N}_{A} ( x , z ) - {N}_{D} ( x , z ) ] = ρ ( x , z ) \qquad ( 12 )$$

where ∈ is the permittivity, e is the electron charge, N_{A} is the acceptor concentration, and N_{D} is the donor concentration. A gate potential V_{GS} is included by imposing Dirichlet boundary conditions at the domain edge representing the oxide-metal interface. A zero-normal derivative is imposed on all other boundaries [6]. This is a computationally less expensive method that addresses the problem of unphysical electron depletion or accumulation at the lead-device interface (which typically occurs at high V_{DS}).

For example, equation 2 may be discretized using the finite element method with the same rectangular mesh as used to form the two-dimensional Schrödinger equation for the spatially discretized representation of the semiconductor device.

A linear system of equations Lv=c may then obtained, where L is a N×N matrix representing the discretization of the Laplace operator, v is a N×1 column vector representing the unknown potential V, and c is a N×1 column vector representing the known charge ρ(x, z). L will have the same structure as the matrix in equation 7, and is obtained according to a similar method. The elements in the matrix may then be calculated using equations that replace the reciprocal mass with the permittivity. In this example, the boundary conditions are zero normal derivative, and therefore no modifications are needed to incorporate them. A solution to linear system of equations can then be determined using the methods of cyclic reduction described herein (for example, the method 100).

Therefore, in some embodiments, step 120 may comprise executing the method 600 to estimate the electrostatic potential distribution in the semiconductor device.

At step 622, the method 600 comprises determining whether convergence has been achieved. For example, it may be determined that convergence has been achieved if an error between the present potential, and the previous potential, is less than a predefined threshold.

If it is determined that convergence has been achieved, the present potential is considered a self-consistent solution which describes the device correctly [8], the determined current is saved, and the method 600 moves to step 624, else, the method moves to step 606, and the potential is updated with the electrostatic potential distribution determined following the execution of the step 620. That is, the current-voltage characteristics of the semiconductor device are determined when a self-consistent solution of the semiconductor device has been determined.

At step 624, the method 600 comprises determining whether all the bias points have been simulated. If it is determined that all the bias points have been simulated, the method 600 ends, else, the method returns to step 604, where a new bias point is set. The method then proceeds to step 606, and the previous self-consistent potential (that is, the potential that previously achieved convergence) is set as the updated potential.

Thus, when the method 600 ends, all the bias points have been simulated, and the corresponding determined currents for each bias point can then be plotted as I-V curves.

Advantages of estimating a property of a semiconductor device utilizing the “additional layer” BCR methods described herein, and the quantum annealing processes described herein, are now described.

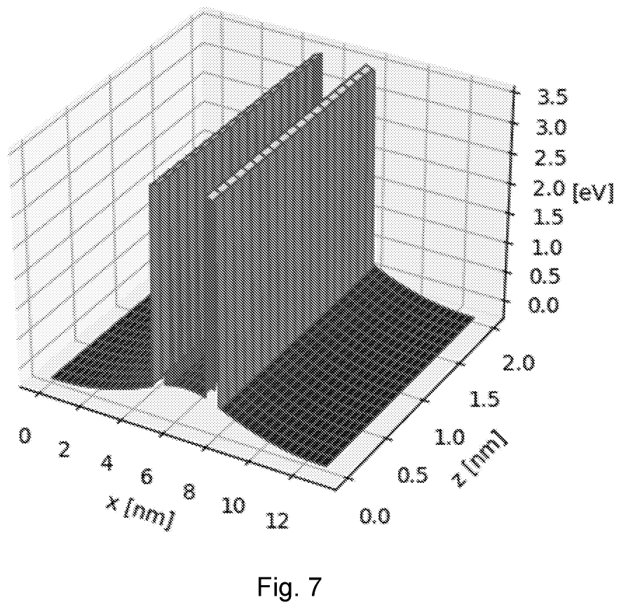

FIG. 7 illustrates an initial potential distribution for a resonant tunneling device.

Using an initial potential (as illustrated in FIG. 7) for a resonant tunneling device (RTD), the solution obtained when solving a discretized Schrödinger equation for the RTD using a BCR method with no additional layer, solving a discretized Schrödinger equation for the RTD using a BCR method with an additional layer, and the solution obtained when solving a discretized Schrödinger equation for the RTD for the initial system of equations (that is, the “whole linear system” solution), can be compared. In this embodiment, the RTD is 13 nm long and 2 nm high. Two SiO 2 layers with a thickness of 0.5 nm define a 2 nm×2 nm undoped well region. The 5 nm long cathode and anode are doped with a doping concentration N_{D}=10²⁰ cm³. In this embodiment, nₓ=130 and n_{z}=20. Therefore, a total of nₓ×n_{z}=2600 nodal points are used.

As a measure of the error, the root mean square (RMS) of the wave functions

$${Φ}_{β}^{S}$$

are computed, where the whole linear system solution is considered the “correct” solution.

In this embodiment, injection is only considered from the left lead, and the cut-off energy is set to approximately 1.25 eV, resulting in 32 injection energies. In this embodiment, when solving the discretized Schrödinger equation for the RTD using the BCR method with an additional layer, the 5^{th} layer of the RTD is used as the additional layer.

The two standing-wave eigenenergies which discretize the energy spectrum are looked at separately. The “sinus-like” eigenenergies are referred to as Type 1 energies, and the “cosinus-like” eigenenergies are referred to as Type 2 energies. In this embodiment, the wave-functions have not been normalized.

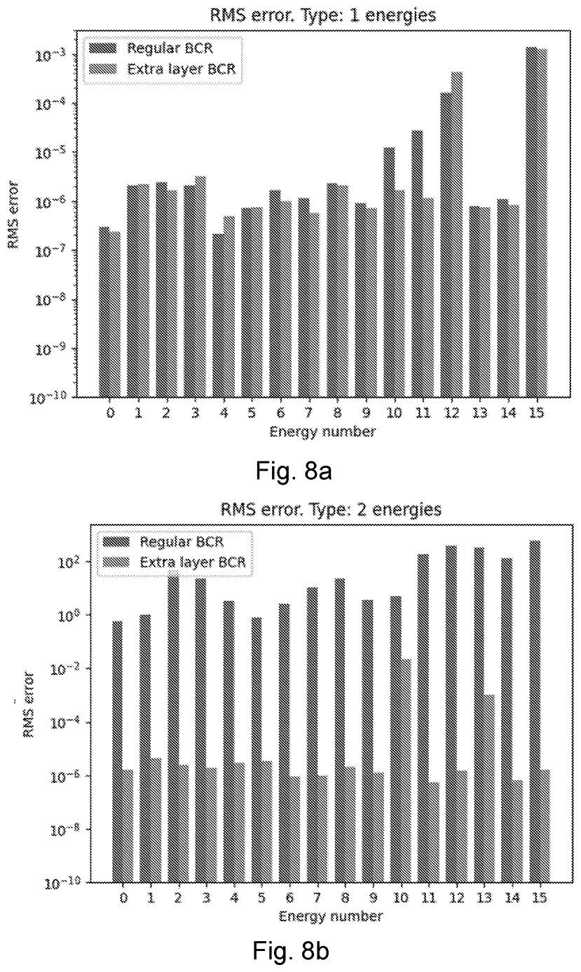

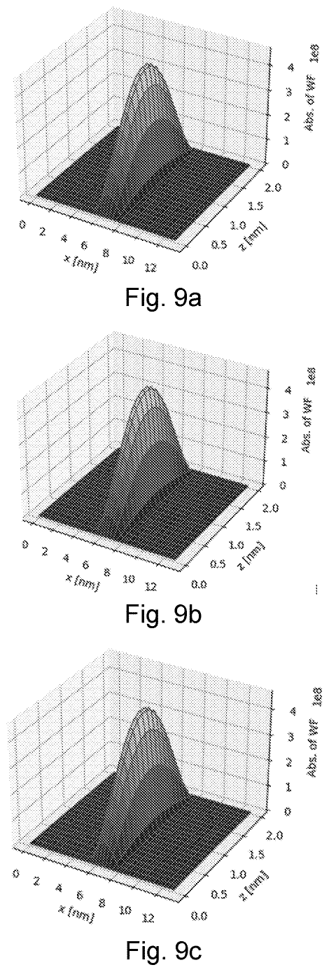

FIG. 8a illustrates the root mean square error for different Type 1 energies. FIG. 8b illustrates the root mean square error for different Type 2 energies. FIG. 9a illustrates the wave function of the RTD for the 10th Type 2 energy, obtained using the linear equation solver. FIG. 9b illustrates the wave function of the RTD for the 10th Type 2 energy, obtained using the regular BCR method. FIG. 9c illustrates the wave function of the RTD for the 10th Type 2 energy, obtained using the additional layer BCR method.

As illustrated in FIGS. 8a and 8b, a very similar error is obtained for almost all Type 1 energies and the “regular” BCR method and the “additional layer” BCR method perform similarly.

However, as shown in FIG. 8b, for Type 2 energies, the “additional layer” BCR method produces much more accurate solutions for most of the energies.

As noted above, when performing matrix inversion using a quantum annealing method, the objective function for the matrix inverse can be constructed in two different ways. In some embodiments, the objective function can be constructed as a whole matrix objective function (as is the case for the methods 400 and 500 described herein, referred to as the “whole matrix solver”), or the matrix inversion can be constructed as a Linear Least Square QUBO model with the right hand side being the unit vectors, as described in [11](referred to as the “unit vector solver”). Results comparing these two approaches when computing the matrix inverse of the tri-diagonal matrix A, where A is given by:

$$A = [ \begin{matrix}- 2 & 1 & 0 & … & 0 \\ 1 & - 2 & 1 & ⋱ & ⋮ \\ 0 & ⋱ & ⋱ & ⋱ & 0 \\ ⋮ & ⋱ & 1 & - 2 & 1 \\ 0 & … & 0 & 1 & - 2\end{matrix} ]$$

are now discussed.

The matrix A has the same structure as the matrices that are decoupled in the 1st decoupling stage of the BCR method described with reference to FIG. 3. The matrix A is sparse and because of this, embedding of the binary quadratic model (BQM) on the quantum annealer does not require the same connectivity that would be required if the matrix A was dense. This reduces the number of physical qubits that needed to embed the model. This property is exploited when embedding the model for the “whole matrix solver”, which requires more qubits than the “unit vector solver”.

In the unit vector approach, a solution for the BQM created from the LLS objective function is sampled for different right-hand side unit vectors. As the problem is the same for all the objective functions (as the matrix A is the same each time), the same embedding can be used for each anneal. The only thing that differs is the weights, which are adjusted when the sampler is called for a specific unit vector BQM. That is, the same embedding can be used for all the unit vectors. This is beneficial, as embedding is a time-consuming task. As the problem then must be solved for all the unit vectors in the unit vector approach, several sampling times are obtained. The total sampling time from all the samplings is the value presented in Tables 1, 2 and 3.

Tables 1, 2 and 3 comprise embedding and annealing times for matrix inversion methods implemented on a quantum annealer, using 3 qubit accuracy and 100 annealing circles. The RMS error is computed for the lowest energy sample. WHS=Whole Matrix Solver. UVS=Unit Vector Solver.

TABLE 1

| Matrix size | 5 × 5 | 6 × 6 | 7 × 7 | 8 × 8 | 9 × 9 | 10 × 10 |
|---|---|---|---|---|---|---|
| Embedding | 3.787108 | 4.375526 | 4.093422 | 8.597509 | 7.391740 | 8.927392 |
| time WMS | | | | | | |
| [s] | | | | | | |
| Sampling | 32.917 | 29.067 | 46.346 | 62.530 | 76.841 | 74.717 |
| time WMS | | | | | | |
| [ms] | | | | | | |
| Logical | 75 | 108 | 147 | 192 | 243 | 300 |
| qubits | | | | | | |
| WMS | | | | | | |
| Physical | 156 | 227 | 353 | 456 | 569 | 740 |
| qubits | | | | | | |
| WMS | | | | | | |
| RMS error | 0.155065 | 0.183223 | 0.192029 | 0.239608 | 0.282303 | 0.349393 |
| WMS | | | | | | |
| Embedding | 3.515022 | 3.569846 | 3.640435 | 4.929300 | 6.760475 | 9.809062 |
| time UVS | | | | | | |
| [s] | | | | | | |
| Tot. | 97.065 | 100.659 | 207.332 | 247.830 | 268.645 | 296.733 |
| sampling | | | | | | |
| time UVS | | | | | | |
| [ms] | | | | | | |
| Logical | 15 | 18 | 21 | 24 | 27 | 30 |
| qubits UVS | | | | | | |
| Physical | 34 | 47 | 60 | 82 | 98 | 124 |
| qubits UVS | | | | | | |
| RMS error | 0.163246 | 0.197081 | 0.160062 | 0.240180 | 0.274895 | 0.364064 |
| UVS | | | | | | |

TABLE 2

| Matrix size | 11 × 11 | 12 × 12 | 13 × 13 | 14 × 14 | 15 × 15 | 16 × 16 |
|---|---|---|---|---|---|---|
| Embedding | 12.559210 | 16.898327 | 17.102410 | 20.886657 | 18.220348 | 88.843074 |
| time WMS | | | | | | |
| [s] | | | | | | |
| Sampling | 96.006 | 161.985 | 286.886 | 212.740 | 579.663 | 285.967 |
| time WMS | | | | | | |
| [ms] | | | | | | |
| Logical | 363 | 426 | 498 | 576 | 660 | 750 |
| qubits | | | | | | |
| WMS | | | | | | |
| Physical | 911 | 1076 | 1366 | 1587 | 1824 | 2198 |
| qubits | | | | | | |
| WMS | | | | | | |
| RMS error | 0.300349 | 0.366480 | 0.421162 | 0.450764 | 0.440341 | 0.487875 |
| WMS | | | | | | |
| Embedding | 12.267178 | 8.180394 | 9.763127 | 14.062302 | 29.533599 | 35.546644 |
| time UVS | | | | | | |
| [s] | | | | | | |
| Tot. | 496.056 | 406.117 | 516.697 | 610.163 | 955.900 | 914.677 |
| sampling | | | | | | |
| time UVS | | | | | | |
| [ms] | | | | | | |
| Logical | 33 | 36 | 39 | 42 | 45 | 48 |
| qubits | | | | | | |
| UVS | | | | | | |
| Physical | 147 | 191 | 211 | 248 | 254 | 326 |
| qubits | | | | | | |
| UVS | | | | | | |
| RMS error | 0.373167 | 0.315537 | 0.424001 | 0.400299 | 0.448990 | 0.590392 |
| UVS | | | | | | |

TABLE 3

| Matrix size | 17 × 17 | 18 × 18 | 19 × 19 | 20 × 20 | 21 × 21 | 22 × 22 |
|---|---|---|---|---|---|---|
| Embedding | 120.761445 | 206.347493 | 127.960260 | 158.455197 | 175.970814 | 633.731196 |
| time WMS | | | | | | |
| [s] | | | | | | |
| Sampling | 409.993 | 363.156 | 420.914 | 537.626 | 602.084 | 806.876 |
| time WMS | | | | | | |
| [ms] | | | | | | |
| Logical | 846 | 948 | 1056 | 1170 | 1290 | 1386 |
| qubits | | | | | | |
| WMS | | | | | | |
| Physical | 2502 | 2807 | 3016 | 3312 | 3681 | 4029 |
| qubits | | | | | | |
| WMS | | | | | | |
| RMS | 0.597358 | 0.525439 | 0.589361 | 0.666625 | 0.750231 | 0.724590 |
| error | | | | | | |
| WMS | | | | | | |
| Embedding | 23.671692 | 36.688154 | 25.563607 | 30.106782 | 34.316238 | 90.679036 |
| time UVS | | | | | | |
| [s] | | | | | | |
| Tot. | 1426.280 | 1287.725 | 1826.708 | 1689.135 | 1785.174 | 2057.731 |
| sampling | | | | | | |
| time UVS | | | | | | |
| [ms] | | | | | | |
| Logical | 51 | 54 | 57 | 60 | 63 | 66 |
| qubits | | | | | | |
| UVS | | | | | | |
| Physical | 354 | 398 | 409 | 566 | 494 | 568 |
| qubits | | | | | | |
| UVS | | | | | | |
| RMS | 0.581689 | 0.590786 | 0.504415 | 0.663391 | 0.564284 | 0.633990 |
| error | | | | | | |
| UVS | | | | | | |

Tables 1, 2 and 3 include the embedding time, the sampling time, the number of logical qubits, the number physical qubits, the RMS error and the maximal attainable error for the chosen domains for both the whole matrix approach, and the unit vector approach. In this embodiment, the D-wave quantum annealer chip Advantage System 4.1 is used as the sampler. 100 annealing circles are performed with a qubit accuracy of 3 qubits.

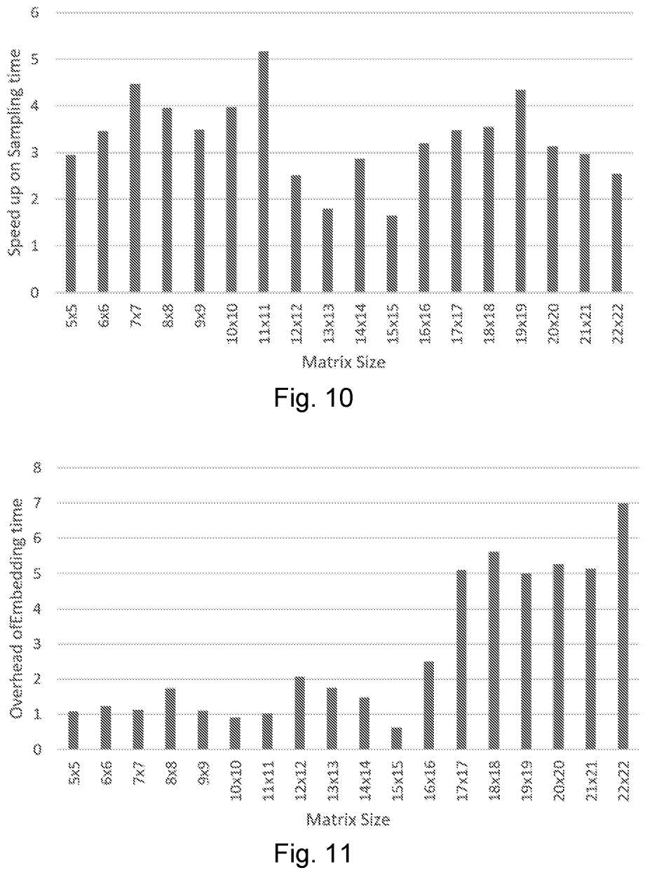

FIG. 10 illustrates the speed up of the whole matrix approach (described with reference to FIGS. 4 and 5) compared to unit vector approach (described in [11]). FIG. 11 illustrates the embedding overhead for the whole matrix approach compared to unit vector approach.

FIG. 10 shows that the whole matrix approach, overall, can compute matrix inverses approximately 3 times faster than the unit vector approach. As shown in FIG. 11, for smaller matrices, the embedding overhead is the same for both approaches, but this overhead can increase 7 times for the whole matrix approach for larger matrices. However, when the whole matrix approach is used in the methods of estimating a property of a semiconductor device described herein, and the methods of simulating a semiconductor device described herein, it will be appreciated that, as the matrix structure remains the same (as this is based on the semiconductor device configuration), the embedding only needs to be performed once. Therefore, the cost of this embedding can be neglected in these methods.

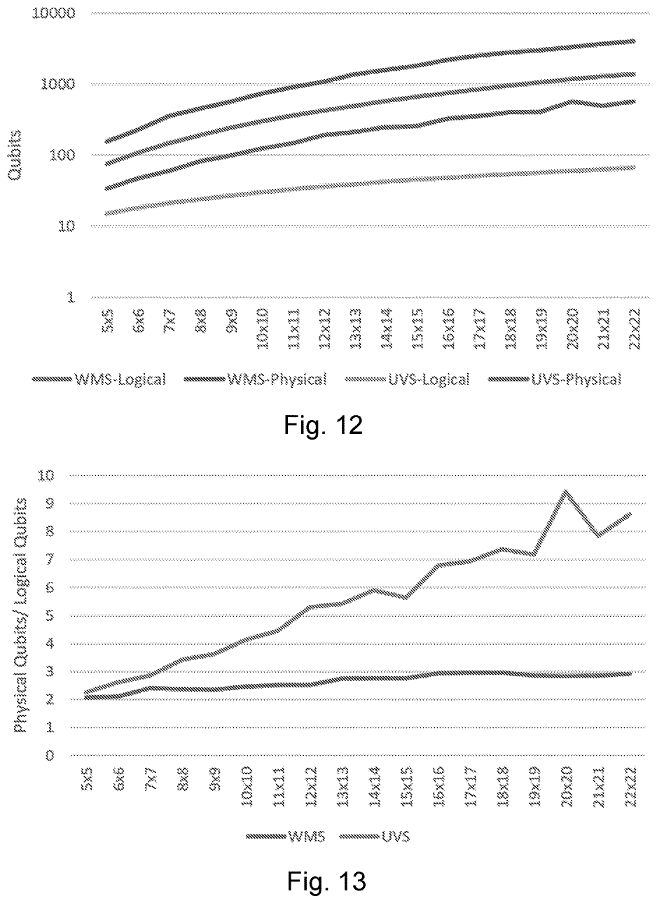

FIG. 12 illustrates the qubit requirements for both the whole matrix approach and the unit vector approach. FIG. 13 illustrates the resource efficiency for both the whole matrix approach and the unit vector approach.

Considering the qubit usage for the two approaches, the logical qubits scale as expected, with the whole matrix approach scaling quadratically, and the unit vector approach scaling linearly, in the amount of logical qubits. The scaling seems to be similar for the physical qubits, as shown in FIG. 12. Looking at the ratio of physical and logical qubits (the resource efficiency) in FIG. 13, provides a practical indication the physical qubit usage. The ratio for the whole matrix approach is close to constant for the different matrix sizes, whilst the unit vector approach shows a linear increase in the physical qubit usage. The whole matrix approach has a better usage of physical qubits, as zero interactions have been removed, and thus reduced the necessary connectivity.

The number of qubits in the annealer limits the size of block matrices in the discretized Schrödinger equation. Therefore, during the discretization of the device with rectangular mesh, the number of nodal points to be simulated in each layer may be selected such that the corresponding QUBO matrices corresponding to these layers can be embedded on a given annealer.

Certain embodiments herein may therefore simulate quantum effects in sub-10 nm transistor technologies by employing a self-consistent model of the non-linear coupled Schrödinger-Poisson equation. In some embodiments, the self-consistent model is solved by implementing a Quadratic Unconstrained Boundary Optimization problem on a Quantum Annealer. In some embodiments, a Block Cyclic Reduction based Domain Decomposition Method is utilized to make the self-consistent model of the non-linear coupled Schrödinger-Poisson equation tractable to solve on a Quantum Annealer.

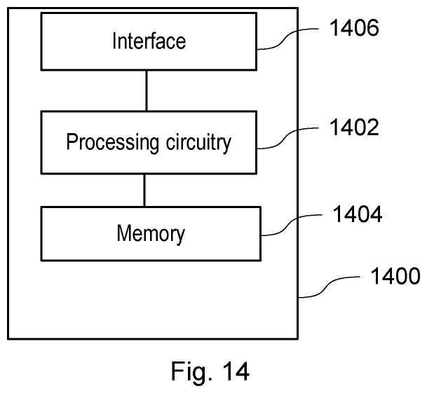

FIG. 14 is a schematic of an example of an apparatus 1400 for estimating a property of a semiconductor device. The apparatus 1400 comprises processing circuitry 1402 (e.g. one or more processors) and a memory 1404 in communication with the processing circuitry 1402. The memory 1404 contains instructions executable by the processing circuitry 1402. The apparatus 1400 also comprises an interface 1406 in communication with the processing circuitry 1402. Although the interface 1406, processing circuitry 1402 and memory 1404 are shown connected in series, these may alternatively be interconnected in any other way, for example via a bus.

In one embodiment, the memory 1404 contains instructions executable by the processing circuitry 1402 such that the apparatus 1400 is operable to form a spatially discretized representation of the semiconductor device comprising nₓ layers; initialize a first system of equations based on one or more parameters relating to the spatially discretized representation of the semiconductor device, wherein the first system of equations represent the property of the semiconductor device, wherein each equation of the first system of equations represents layer i, where i=(1, 2, . . . nₓ₋₁, nₓ), and comprises one or more matrix blocks H_{i,j}, where j=(1, 2, . . . nₓ₋₁, nₓ), and wherein each matrix block represents either:
one or more interactions within layer i, or
one or more interactions between a layer i, and a layer adjacent to layer i in the spatially discretized representation; apply a method of cyclic reduction to the first system of equations to obtain a second system of equations; determine a solution to the second system of equations; and estimate the property of the semiconductor device based on the solution to the second system of equations. In some examples, the apparatus 1400 is operable to carry out the method 100 described above with reference to FIG. 1.

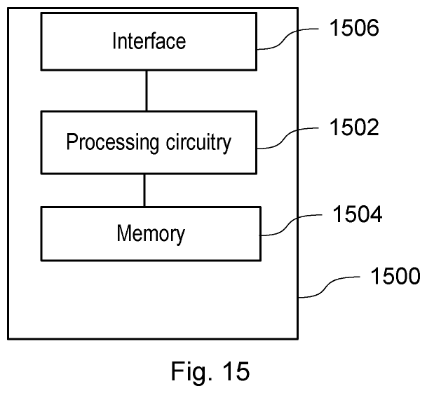

FIG. 15 is a schematic of an example of an apparatus 1500 for entries of a N×N matrix B, where the matrix B is the inverse of a N×N matrix A. The apparatus 1500 comprises processing circuitry 1502 (e.g. one or more processors) and a memory 1504 in communication with the processing circuitry 1502. The memory 1504 contains instructions executable by the processing circuitry 1502. The apparatus 1500 also comprises an interface 1506 in communication with the processing circuitry 1502. Although the interface 1506, processing circuitry 1502 and memory 1504 are shown connected in series, these may alternatively be interconnected in any other way, for example via a bus.

In one embodiment, the memory 1504 contains instructions executable by the processing circuitry 1502 such that the apparatus 1500 is operable to, for each entry of B, form a representation of the entry of B that comprises one or more binary variables; form, based on the representations of the entries of B, N² linear equality constraints that represent A·B=I, where I is an N×N identity matrix; formulate a quadratic unconstrained binary optimization, QUBO, problem based on the N² linear equality constraints; execute the QUBO problem on a quantum computing device to obtain a set of values of the binary variables; and use the set of values of the binary variables to determine the entries of matrix B. In some examples, the apparatus 1500 is operable to carry out the method 400 described above with reference to FIG. 4.

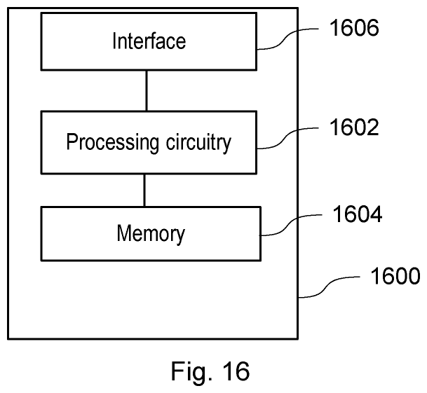

FIG. 16 is a schematic of an example of a data processing apparatus 1600 for determining entries of a N×N matrix B for use in a method of estimating a property of a semiconductor device, where the matrix B is the inverse of a N×N matrix A, and where the entries of the matrix A represent interactions within a layer of a spatially discretized representation of the semiconductor device. The data processing apparatus 1600 comprises processing circuitry 1602 (e.g. one or more processors) and a memory 1604 in communication with the processing circuitry 1602. The memory 1604 contains instructions executable by the processing circuitry 1602. The data processing apparatus 1600 also comprises an interface 1606 in communication with the processing circuitry 1602. Although the interface 1606, processing circuitry 1602 and memory 1604 are shown connected in series, these may alternatively be interconnected in any other way, for example via a bus.

In one embodiment, the memory 1604 contains instructions executable by the processing circuitry 1602 such that the data processing apparatus 1600 is operable to for each entry of B, form a representation of the entry of B that comprises one or more binary variables; form, based on the representations of the entries of B, N² linear equality constraints that represent A·B=I, where I is an N×N identity matrix; formulate a quadratic unconstrained binary optimization, QUBO, problem based on the N² linear equality constraints; execute the QUBO problem on a quantum computing device to obtain a set of values of the binary variables; and use the set of values of the binary variables to determine the entries of matrix B. In some examples, the data processing apparatus 1600 is operable to carry out the method 500 described above with reference to FIG. 5.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. C. S. Lent and D. J. Kirkner, “The quantum transmitting boundary method,” Journal of Applied Physics, vol. 67, no. 10, pp. 6353-6359, 1990. eprint: https://doi.org/10.1063/1.345156
2. M. G. Ancona, “Density-gradient theory: A macroscopic approach to quantum confinement and tunneling in semiconductor devices,” Journal of Computational Electronics, vol. 10, no. 1, pp. 65-97, 2011
3. N. Sano, A. Hiroki, and K. Matsuzawa, “Device modeling and simulations toward sub-10 nm semiconductor devices,” IEEE Transactions on Nanotechnology, vol. 1, no. 1, pp. 63-71, 2002
4. R. A. Sweet, “A cyclic reduction algorithm for solving block tridiagonal systems of arbitrary dimension,” SIAM Journal on Numerical Analysis, vol. 14, no. 4, pp. 706-720, 1977
5. G. Grosso, S. Moroni, and G. P. Parravicini, “Electronic structure of the inas-gasb superlattice studied by the renormalization method,” Phys. Rev. B, vol. 40, pp. 12 328-12 337, 18 Dec. 1989
6. P. B. Vyas, M. L. Van de Put, and M. V. Fischetti, “Master-equation study of quantum transport in realistic semiconductor devices including electron-phonon and surface-roughness scattering,” Phys. Rev. Applied, vol. 13, p. 014 067, 1 Jan. 2020
7. S. E. Laux, A. Kumar, and M. V. Fischetti, “Analysis of quantum ballistic electron transport in ultrasmall silicon devices including space-charge and geometric effects,” Journal of Applied Physics, vol. 95, no. 10, pp. 5545-5582, 2004
8. P. B. Vyas, C. Naquin, H. Edwards, M. Lee, W. G. Vandenberghe, and M. V. Fischetti, “Theoretical simulation of negative differential transconductance in lateral quantum well nmos devices,” Journal of Applied Physics, vol. 121, no. 4, p. 044 501, 2017
9. T. B. Boykin, M. Luisier, and G. Klimeck, “Multiband transmission calculations for nanowires using an optimized renormalization method,” Phys. Rev. B, vol. 77, p. 165 318, 16 Apr. 2008
10. M. Luisier, G. Klimeck, A. Schenk, W. Fichtner, and T. B. Boykin, “A parallel sparse linear solver for nearest-neighbor tight-binding problems,” in Euro-Par 2008—Parallel Processing, E. Luque, T. Margalef, and D. Benitez, Eds., Berlin, Heidelberg: Springer Berlin Heidelberg, 2008, pp. 790-800
11. M. L. Rogers and R. L. Singleton, “Floating-point calculations on a quantum annealer: Division and matrix inversion,” Frontiers in Physics, vol. 8, 2020
12. T. Fukushima, “Precise and fast computation of inverse fermi-dirac integral of order 1/2 by minimax rational function approximation,” Applied Mathematics and Computation, vol. 259, pp. 698-707, 2015
13. Zhou, J. R. and Ferry, D. K., 1992. Simulation of ultra-small GaAs MESFET using quantum moment equations. IEEE Transactions on Electron Devices, 39(3), pp. 473-478
14. D. Ferry, R. Akis, and D. Vasileska, “Quantum effects in mosfets: Use of an effective potential in 3d monte carlo simulation of ultra-short channel devices,” in International Electron Devices Meeting 2000. Technical Digest. IEDM (Cat.No.000H37138), 2000, pp. 287-290
15. M. V. Fischetti, “Theory of electron transport in small semiconductor devices using the pauli master equation,” Journal of Applied Physics, vol. 83, no. 1, pp. 270-291, 1998. eprint: https://doi.org/10.1063/1.367149
16. Fischetti, M. V., 1999. Master-equation approach to the study of electronic transport in small semiconductor devices. Physical Review B, 59(7), p. 4901

1-47. (canceled)

48. A method of estimating a property of a semiconductor device, the method comprising:
forming a spatially discretized representation of the semiconductor device comprising nₓ layers;
initializing a first system of equations based on one or more parameters relating to the spatially discretized representation of the semiconductor device, wherein the first system of equations represent the property of the semiconductor device, wherein each equation of the first system of equations represents layer i, where i=(1, 2, . . . nₓ₋₁, nₓ), and comprises one or more matrix blocks H_{i,j}, where j=(1, 2, . . . nₓ₋₁, nₓ), and wherein each matrix block represents either:
one or more interactions within layer i, or
one or more interactions between a layer i, and a layer adjacent to layer i in the spatially discretized representation;
applying a method of cyclic reduction to the first system of equations to obtain a second system of equations, wherein applying the method of cyclic reduction to the first system of equations to obtain the second system of equations comprises:
for one or more layers of the spatially discretized representation:
for layer i, where layer i is coupled to layer i−1 and layer i+r; and
renormalizing the matrix blocks H_{i-1,j}, H_{i+r,i}, H_{i,i-1} and H_{i,i+r} of the first system of equations, wherein renormalizing the matrix blocks H_{i-1,j}, H_{i+r,i}, H_{i,i-1} and H_{i,i+r} comprises: i) determining an inverse matrix (B) of the matrix block H_{i,i}; and ii) renormalizing the matrix blocks H_{i-1,i}, H_{i+r,i}, H_{i,i-1} and H_{i,i+r} based on the determined one or more inverse matrices, wherein
the inverse matrix B is determined by: for each entry of B,
forming a representation of the entry of B that comprises one or more binary variables;
forming, based on the representations of the entries of B, N² linear equality constraints that represent A·B=I, where I is an N×N identity matrix;
formulating a quadratic unconstrained binary optimization, QUBO, problem based on the N² linear equality constraints;
executing the QUBO problem on a quantum computing device to obtain a set of values of the binary variables; and
using the set of values of the binary variables to determine the entries of matrix B;
determining a solution to the second system of equations; and
estimating the property of the semiconductor device based on the solution to the second system of equations.

49. The method of claim 48, wherein forming a spatially discretized representation of the semiconductor device comprises:
using a finite element method to form the spatially discretized representation of the semiconductor device.

50. The method of claim 49, wherein using the finite element method to form the spatially discretized representation of the semiconductor device comprises using rectangular mesh elements, where each rectangular mesh element represents a spatial portion of the device.

51. The method of claim 48, wherein the one or more layers of the spatially discretized representation comprises all layers except layer 1 and layer nₓ of the spatially discretized representation.

52. The method of claim 51, wherein renormalizing the matrix blocks for the one or more layers is performed first for one or more evenly indexed layers of the one or more layers of the spatially discretized representation.

53. The method of claim 52, further comprising, after renormalizing the matrix blocks for the one or more evenly indexed layers, renormalizing the matrix blocks for half of oddly indexed layers of the one or more layers of the spatially discretized representation.

54. The method of claim 53, further comprising renormalizing the matrix blocks for remaining layers of the one or more layers of the spatially discretized representation.

55. The method of claim 48, wherein the one or more layers of the spatially discretized representation comprises all layers except layer 1, layer nₓ, and a further layer of the spatially discretized representation.

56. The method of claim 55, wherein
the method further comprises selecting the further layer of the spatially discretized representation, and
the step of selecting the further layer comprises selecting the further layer based on: i) a magnitude of a wave function of the spatially discretized representation of the semiconductor device and ii) a magnitude of a wave function of the further layer.

57. The method of claim 48, where the entries of the matrix A represent interactions within a layer of a spatially discretized representation of a semiconductor device.

58. The method of claim 48, wherein executing the QUBO problem on the quantum computing device comprises performing a quantum annealing process.

59. The method of claim 48, wherein the method is for use in a method of estimating a property of a semiconductor device.

60. The method of claim 59, wherein the property comprises a wave function in the semiconductor device.

61. The method of claim 59, wherein the property comprises an electrostatic potential in the semiconductor device.

62. The method of claim 48, wherein the method is for use in a method of simulating a semiconductor device and/or a circuit comprising the semiconductor device.

63. The method of claim 48, wherein the method is performed on a data processing apparatus.

64. A non-transitory computer readable media having stored thereon a computer program comprising instructions which, when executed on at least one processor, cause the at least one processor to carry out a method of claim 48.

65. An apparatus for estimating a property of a semiconductor device, wherein the apparatus comprises:
memory; and
processing circuitry, wherein the apparatus is configured to perform a method comprising:
forming a spatially discretized representation of the semiconductor device comprising nₓ layers;
initializing a first system of equations based on one or more parameters relating to the spatially discretized representation of the semiconductor device, wherein the first system of equations represent the property of the semiconductor device, wherein each equation of the first system of equations represents layer i, where i=(1, 2, . . . nₓ₋₁, nₓ), and comprises one or more matrix blocks H_{i,j}, where j=(1, 2, . . . nₓ₋₁, nₓ), and wherein each matrix block represents either:
one or more interactions within layer i, or
one or more interactions between a layer i, and a layer adjacent to layer i in the spatially discretized representation;
applying a method of cyclic reduction to the first system of equations to obtain a second system of equations, wherein applying the method of cyclic reduction to the first system of equations to obtain the second system of equations comprises:
for one or more layers of the spatially discretized representation:
for layer i, where layer i is coupled to layer i−1 and layer i+r; and
renormalizing the matrix blocks H_{i-1,i}, H_{i+r,i}, H_{i,i-i} and H_{i,i+r} of the first system of equations, wherein renormalizing the matrix blocks H_{i-1,i}, H_{i+r,i}, H_{i,i-1} and H_{i,i+r} comprises: i) determining an inverse matrix (B) of the matrix block H_{i,i}; and ii) renormalizing the matrix blocks H_{i-1,i}, H_{i+r,i}, H_{i,i-1} and H_{i,i+r} based on the determined one or more inverse matrices, wherein the inverse matrix B is determined by: for each entry of B,
forming a representation of the entry of B that comprises one or more binary variables;
forming, based on the representations of the entries of B, N² linear equality constraints that represent A·B=I, where I is an N×N identity matrix;
formulating a quadratic unconstrained binary optimization, QUBO, problem based on the N² linear equality constraints;
executing the QUBO problem on a quantum computing device to obtain a set of values of the binary variables; and
using the set of values of the binary variables to determine the entries of matrix B;
determining a solution to the second system of equations; and
estimating the property of the semiconductor device based on the solution to the second system of equations.
